(19) United States
(12) Patent Application Publication
(10) Pub. No.: US 2009/0316557 A1
(43) Pub. Date: Dec. 24, 2009

(54) INFORMATION REPRODUCING APPARATUS AND METHOD, AND COMPUTER PROGRAM

(76) Inventors: Yoshio Sasaki, Saitama (JP); Shogo Miyanabe, Saitama (JP); Hiroyuki Uchino, Saitama (JP)

Correspondence Address: YOUNG & THOMPSON, 209 Madison Street, Suite 500, Alexandria, VA, 22314, US

(21) Appl. No.: 12/446,839

(22) PCT Filed: Oct. 31, 2006
(86) PCT No.: PCT/JP2006/321786

§ 371 Date: Apr. 23, 2009

(51) Int. Cl. G11B 20/10

(52) U.S. Cl. 369/59.17; G9B/20.009

(57) ABSTRACT

An information reproducing apparatus (1) is provided with: an amplitude limiting device (151, 152) for obtaining an amplitude limit signal (RS_{LIM}) by limiting an amplitude level of a read signal (R_{RF}) read from a recording medium (100) on the basis of a predetermined amplitude limit value (L); a filtering device (153) for obtaining an equalization-corrected signal by performing a high-frequency emphasizing and filtering process on the amplitude limit signal; and an adjusting device (18) for variably adjusting a reference level which indicates a reference point of the amplitude level on the amplitude limiting device.

### TECHNICAL FIELD

The present invention relates to an information reproducing apparatus and method which reproduce record data recorded on a recording medium, and in particular, an information reproducing apparatus and method which perform waveform equalization, such as a filtering process, on a read signal obtained by reading the record data recorded on the recording medium, as well as a computer program which makes a computer function as the information reproducing apparatus.

### BACKGROUND ART

In order to improve an SN ratio of a read signal, read from the recording medium on which the data is recorded at high density, there is known a technology in which a filtering process for emphasizing high frequencies is performed on the read signal, for waveform equalization. In particular, according to a patent document 1, the technology is disclosed that the high frequencies are emphasized without any intersymbol interference by performing the filtering process after amplitude limit is performed on the read signal (a technology about a so-called limit equalizer).

Patent document 1: Japanese Patent No. 3459563

### DISCLOSURE OF INVENTION

### Subject to be Solved by the Invention

On the limit equalizer, in terms of circuit configuration, a zero level is a value of the read signal (i.e. an average position of the amplitude center of the read signal). Therefore, if the value is zero, the zero level coincides with the amplitude center of the read signal obtained by reading a record mark with the shortest run length (e.g. the record data with a run length of 3T in a DVD, and the record data with a run length of 2T in a Blu-ray Disc). On the other hand, as more asymmetry occurs, the zero level deviates farther from the amplitude center of the read signal obtained by reading the record mark with the shortest run length. In general, the limit equalizer has an effect of raising an edge of the read signal by performing high-frequency emphasis and amplitude limit. Thus, it is advantageous to the asymmetry that occurs to some degree. In this case, however, if the deviation extremely increases (i.e. if the asymmetry extremely increases), reproduction features are significantly deteriorated, which is a technical problem.

In view of the aforementioned problems, it is therefore an object of the present invention to provide an information reproducing apparatus and method which can perform the waveform equalization while performing the amplitude limit in a better manner, as well as a computer program.

### Means for Solving the Subject

The above object of the present invention can be achieved by an information reproducing apparatus provided with: an amplitude limiting device for obtaining an amplitude limit signal by limiting an amplitude level of a read signal read from a recording medium on the basis of a predetermined amplitude limit value; a filtering device for obtaining an equalization-corrected signal by performing a high-frequency emphasizing and filtering process on the amplitude limit signal; and an adjusting device for variably adjusting a reference level which indicates a reference point of the amplitude level on the amplitude limiting device.

The above object of the present invention can be also achieved by an information reproducing method provided with: an amplitude limiting process of obtaining an amplitude limit signal by limiting an amplitude level of a read signal read from a recording medium on the basis of a predetermined amplitude limit value; a filtering process of obtaining an equalization-corrected signal by performing a high-frequency emphasizing and filtering process on the amplitude limit signal; and an adjusting process of variably adjusting a reference level which indicates a reference point of the amplitude level in the amplitude limiting process.

The above object of the present invention can be achieved by a computer program for reproduction control and for controlling a computer provided in an information reproducing apparatus provided with: an amplitude limiting device for obtaining an amplitude limit signal by limiting an amplitude level of a read signal read from a recording medium on the basis of a predetermined amplitude limit value; a filtering device for obtaining an equalization-corrected signal by performing a high-frequency emphasizing and filtering process on the amplitude limit signal; and an adjusting device for variably adjusting a reference level which indicates a reference point of the amplitude level on the amplitude limiting device, the computer program making the computer function as at least one portion of the amplitude limiting device, the filtering device, and the adjusting device.

The operation and other advantages of the present invention will become more apparent from the embodiments explained below.

### BRIEF DESCRIPTION OF DRAWINGS

FIG. 1 is a block diagram conceptually showing the basic structure of an information reproducing apparatus in an example.

FIG. 2 is a block diagram conceptually showing the structure of a limit equalizer in the example.

FIG. 3 is a waveform chart conceptually showing an operation of setting the upper limit and the lower limit of an amplitude limit value on a sample value series.

FIG. 4 are waveform charts conceptually showing an operation of obtaining a high-frequency emphasized read sample value series, on the sample value series.

FIG. 5 are waveform charts conceptually showing the sample value series and a zero level if there is asymmetry

FIG. 6 is a graph conceptually showing a correlation between the asymmetry and a jitter value.

FIG. 7 is a waveform chart conceptually showing a value.

FIG. 8 is a block diagram conceptually showing an offset calculation circuit for calculating an offset value based on the value.

FIG. 9 is a flowchart conceptually showing a flow of one operation of the information reproducing apparatus in the example when the offset value based on the value is calculated.

FIG. 10 is a flowchart conceptually showing a flow of another operation of the information reproducing apparatus in the example when the offset value based on the value is calculated.

FIG. 11 is a waveform chart conceptually showing another value.

FIG. 12 is a block diagram conceptually showing an offset calculation block for calculating an offset value based on another value.

FIG. 13 is a waveform chart conceptually showing an asymmetry value.

FIG. 14 is a block diagram conceptually showing an offset calculation circuit for calculating an offset value based on the asymmetry value.

FIG. 15 is a flowchart conceptually showing a flow of one operation of the information reproducing apparatus in the example when the offset value based on the asymmetry value is calculated.

FIG. 16 is a flowchart conceptually showing a flow of another operation of the information reproducing apparatus in the example when the offset value based on the asymmetry value is calculated.

FIG. 17 is a waveform chart conceptually showing waveform distortion.

FIG. 18 is a block diagram conceptually showing an offset calculation circuit for calculating an offset value based on the waveform distortion.

FIG. 19 is a waveform chart conceptually showing another waveform distortion.

FIG. 20 is a flowchart conceptually showing a flow of one operation of the information reproducing apparatus in the example when the offset value based on the waveform distortion is calculated.

FIG. 21 is a flowchart conceptually showing a flow of another operation of the information reproducing apparatus in the example when the offset value based on the waveform distortion is calculated.

FIG. 22 are waveform charts conceptually showing an operation of obtaining a high-frequency emphasized read sample value series, in each of a case where the zero level is set without adding the offset value corresponding to a waveform distortion amount to the read sample value series and a case where the zero level is adjusted by adding the offset value corresponding to a waveform distortion amount to the read sample value series, on the sample value series with the waveform distortion.

FIG. 23 is a graph showing a change in symbol error rate with respect to a positional relation between the upper limit or lower limit of the amplitude limit value and the waveform distortion.

FIG. 24 is a block diagram conceptually showing the structure of an offset calculation circuit for calculating an offset value on the basis of the waveform distortion amount in view of that synchronization data is included in the record data.

FIG. 25 is a block diagram conceptually showing the basic structure of an information reproducing apparatus in a modified example.

### DESCRIPTION OF REFERENCE CODES

1, 2 information reproducing apparatus
10 spindle motor
11 pickup
12 HPF
13 A/D converter
14 pre-equalizer
15, 25 limit equalizer
16 binary circuit
17 decoding circuit
18 offset calculation circuit
151 amplitude limit value setting block
152 amplitude limit block
1522 interpolation filter
1523 limiter
153 high-frequency emphasis block

### BEST MODE FOR CARRYING OUT THE INVENTION

Hereinafter, as the best mode for carrying out the present invention, an explanation will be given on embodiments of the information reproducing apparatus and method, and the computer program of the present invention.

### (Embodiment of Information Reproducing Apparatus)

An embodiment of the information reproducing apparatus of the present invention is an information reproducing apparatus provided with: an amplitude limiting device for obtaining an amplitude limit signal by limiting an amplitude level of a read signal read from a recording medium on the basis of a predetermined amplitude limit value; a filtering device for obtaining an equalization-corrected signal by performing a high-frequency emphasizing and filtering process on the amplitude limit signal; and an adjusting device for variably adjusting a reference level which indicates a reference point of the amplitude level on the amplitude limiting device.

According to the embodiment of the information reproducing apparatus of the present invention, the amplitude level of the read signal read from the recording medium is limited by the operation of the amplitude limiting device. Specifically, with respect to a signal component of the read signal in which the amplitude level is greater than or equal to an upper limit of the amplitude limit value or is less than or equal to a lower limit of the amplitude limit value, the amplitude level is limited to the upper limit or the lower limit of the amplitude limit value. On the other hand, with respect to a signal component of the read signal in which the amplitude level is less than or equal to the upper limit of the amplitude limit value or is greater than or equal to the lower limit of the amplitude limit value, the amplitude level is not limited. The read signal in which the amplitude level is limited as described above is outputted to the filtering device as the amplitude limit signal. On the filtering device, the high-frequency emphasis filtering process is performed on the amplitude limit signal. As a result, the equalization-corrected signal is obtained. Then, for example, a binary process, a decoding process, and the like are performed on the equalization-corrected signal. By this, it is possible to perform a reproduction process on record data (e.g. video data, audio data, and the like) recorded on the recording medium.

This can limit or control the dispersion (i.e. jitter) of the read signal (or its sample values) on the filtering device, resulting in the high-frequency emphasis on the read signal without intersymbol interference.

In the embodiment, in particular, the reference level (e.g. zero level) which indicates the reference point of the amplitude level (in other words, signal level) on the amplitude limiting device can be adjusted to the predetermined value by the operation of the adjusting device. In other words, the reference value can be appropriately adjusted (in other words, changed) by the information reproducing apparatus, during the reproduction operation, without the reference value being fixed to a fixed value uniquely determined.

Thus, even if asymmetry or the like occurs in the read signal, it is possible to adjust the reference level in view of an influence due to the asymmetry or the like. For example, the reference level can be adjusted to cancel the influence due to the asymmetry or the like. Thus, it is possible to perform the high-frequency emphasis on the read signal without intersymbol interference.

As described above, according to the information reproducing apparatus in the embodiment, it is possible to perform waveform equalization while performing amplitude limit in a better manner.

In one aspect of the embodiment of the information reproducing apparatus of the present invention, the adjusting device adjusts the reference level such that the reference level is a median of a signal level of the read signal obtained by reading record data with the shortest run length.

According to this aspect, for example, even if the reference level determined by default is not the median of the signal level of the read signal obtained by reading the record data with the shortest run length, it is possible to adjust the reference level such that the reference level is the median of the signal level of the read signal obtained by reading the record data with the shortest run length. Therefore, it is possible to perform the waveform equalization while performing the amplitude limit in a better manner.

In another aspect of the embodiment of the information reproducing apparatus of the present invention, the adjusting device adjusts the reference level on the basis of at least one of an asymmetry value, a value, and a waveform distortion amount of the read signal.

According to this aspect, it is possible to adjust the reference level in view of an influence due to an amplitude shift, an amplitude center shift, or the like of each read signal obtained by reading each record data with a different run length. In other words, by adjusting the reference level in accordance with the asymmetry value, the value, and the waveform distortion amount which actually occur, it is possible to perform the amplitude limit and high-frequency adjustment using the optimum reference level.

In an aspect of the information reproducing apparatus in which the reference level is adjusted on the basis of at least one of the asymmetry value, the value, and the waveform distortion amount, as described above, the adjusting device may adjust the reference level by adding an offset value set in accordance with at least one of an asymmetry value, a value, and a waveform distortion amount of the read signal.

By virtue of such construction, it is possible to adjust the reference level, preferably and relatively easily, for example, by adding the offset value set in accordance with the asymmetry value, the value, and the waveform distortion amount which actually occur, to the reference level determined by default.

In an aspect of the information reproducing apparatus in which the reference level is adjusted on the basis of at least one of the asymmetry value, the value, and the waveform distortion amount, as described above, the adjusting device may adjust the reference level such that the reference level does not cross the waveform distortion.

By virtue of such construction, it is possible to preferably prevent such a disadvantage that the amplitude limit cannot be preferably performed by the influence due to the waveform distortion, as detailed later. In other words, it is possible to perform the amplitude limit and high-frequency emphasis while eliminating the influence due to the waveform distortion.

In an aspect of the information reproducing apparatus in which the reference level is adjusted on the basis of at least one of the asymmetry value, the value, and the waveform distortion amount, as described above, the adjusting device may adjust the reference level such that at least one of an upper limit and a lower limit of the amplitude limit value does not cross the waveform distortion.

By virtue of such construction, it is possible to preferably prevent such a disadvantage that the amplitude limit cannot be preferably performed by the influence due to the waveform distortion, as detailed later. In other words, it is possible to perform the amplitude limit and high-frequency emphasis while eliminating the influence due to the waveform distortion.

In an aspect of the information reproducing apparatus in which the reference level is adjusted on the basis of at least one of the asymmetry value, the value, and the waveform distortion amount, as described above, the adjusting device may adjust the reference level such that the reference level is shifted to a side which is opposite to a side where the waveform distortion occurs.

By virtue of such construction, it is possible to preferably prevent such a disadvantage that the amplitude limit cannot be preferably performed by the influence due to the waveform distortion, as detailed later. In other words, it is possible to perform the amplitude limit and high-frequency emphasis while eliminating the influence due to the waveform distortion.

In an aspect of the information reproducing apparatus in which the reference level is adjusted on the basis of at least one of the asymmetry value, the value, and the waveform distortion amount, as described above, the adjusting device may adjust the reference level which is used limiting the amplitude level of the read signal corresponding to user data of record data, in accordance with the waveform distortion amount of the read signal corresponding to the user data, and the adjusting device may adjust the reference level which is used limiting the amplitude level of the read signal corresponding to synchronization data of record data, in accordance with the waveform distortion amount of the read signal corresponding to the synchronization data, the synchronization data being used for synchronization when the user data is reproduced.

By virtue of such construction, it is possible to eliminate the influence due to the waveform distortion even from the read signal corresponding to the synchronization data which is important when the record data is reproduced.

Incidentally, the adjusting device may adjust the reference level which is used in limiting the amplitude of each of the read signal corresponding to the user data and the read signal corresponding to the synchronization data, in accordance with the waveform distortion of the read signal corresponding to the synchronization data.

In another aspect of the embodiment of the information reproducing apparatus of the present invention, the adjusting device adjusts the reference level if there is a read error.

According to this aspect, it is possible to avoid the read error by adjusting the reference level, and as a result, it is possible to maintain the preferable read operation (i.e. reproduction operation).

### (Embodiment of Information Reproducing Method)

An embodiment of the information reproducing method of the present invention is an information reproducing method provided with: an amplitude limiting process of obtaining an amplitude limit signal by limiting an amplitude level of a read signal read from a recording medium on the basis a predetermined amplitude limit value; a filtering process of obtaining an equalization-corrected signal by performing a high-frequency emphasizing and filtering process on the amplitude limit signal; and an adjusting process of variably adjusting a reference level which indicates a reference point of the amplitude level in the amplitude limiting process.

According to the embodiment of the information reproducing method of the present invention, it is possible to receive the same various effects as those that can be received by the aforementioned embodiment of the information reproducing apparatus of the present invention.

Incidentally, in response to the various aspects in the aforementioned embodiment of the information reproducing apparatus of the present invention, the embodiment of the information reproducing method of the present invention can also adopt various aspects.

### (Embodiment of Computer Program)

An embodiment of the computer program of the present invention is a computer program for reproduction control and for controlling a computer provided in an information reproducing apparatus provided with: an amplitude limiting device for obtaining an amplitude limit signal by limiting an amplitude level of a read signal read from a recording medium on the basis of a predetermined amplitude limit value; a filtering device for obtaining an equalization-corrected signal by performing a high-frequency emphasizing and filtering process on the amplitude limit signal; and an adjusting device for variably adjusting a reference level which indicates a reference point of the amplitude level on the amplitude limiting device (i.e. the aforementioned embodiment of the information reproducing apparatus of the present invention (including its various aspects)), the computer program making the computer function as at least one portion of the amplitude limiting device, the filtering device, and the adjusting device.

According to the embodiment of the computer program of the present invention, the aforementioned embodiment of the information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the aforementioned embodiment of the information reproducing apparatus of the present invention, the embodiment of the computer program of the present invention can also employ various aspects.

An embodiment of the computer program product of the present invention is a computer program product in a computer-readable medium for tangibly embodying a program of instructions executable by a computer provided in an information reproducing apparatus provided with: an amplitude limiting device for obtaining an amplitude limit signal by limiting an amplitude level of a read signal read from a recording medium on the basis of a predetermined amplitude limit value; a filtering device for obtaining an equalization-corrected signal by performing a high-frequency emphasizing and filtering process on the amplitude limit signal; and an adjusting device for variably adjusting a reference level which indicates a reference point of the amplitude level on the amplitude limiting device (i.e. the aforementioned embodiment of the information reproducing apparatus of the present invention (including its various aspects)), the computer program product making the computer function as at least one portion of the amplitude limiting device, the filtering device, and the adjusting device.

According to the embodiment of the computer program product of the present invention, the aforementioned embodiment of the information reproducing apparatus of the present invention can be embodied relatively readily, by loading the computer program product from a recording medium for storing the computer program product, such as a ROM (Read Only Memory), a CD-ROM (Compact Disc Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the information reproducing apparatus of the present invention.

Incidentally, in response to the various aspects in the aforementioned embodiment of the information reproducing apparatus of the present invention, the embodiment of the computer program product of the present invention can also employ various aspects.

The operation and other advantages of the present invention will become more apparent from the example explained below.

As explained above, according to the embodiment of the information reproducing apparatus of the present invention, it is provided with the amplitude limiting device, the filtering device, and the adjusting device. According to the embodiment of the information reproducing method of the present invention, it is provided with the amplitude limiting process, the filtering process, and the adjusting process. According to the embodiment of the computer program of the present invention, it makes a computer function as the embodiment of the information reproducing apparatus of the present invention. Therefore, it is possible to perform waveform equalization while performing amplitude limit in a better manner.

### Example

Hereinafter, an example of the present invention will be explained on the basis of the drawings.

(1) Basic Principle

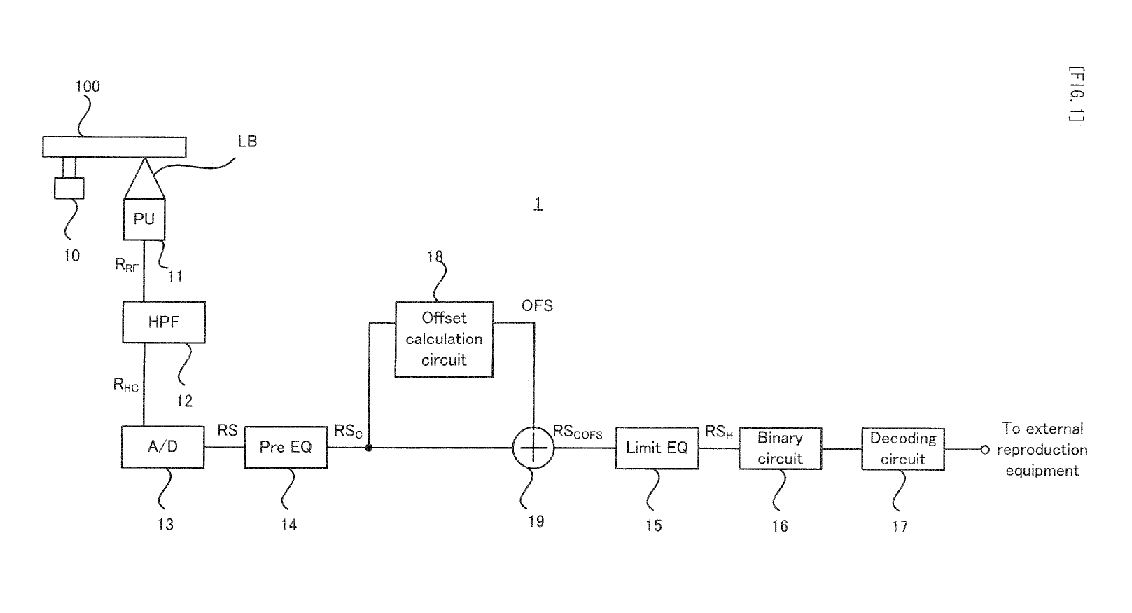

Firstly, with reference to FIG. 1, an example of the information reproducing apparatus of the present invention will be explained. FIG. 1 is a block diagram conceptually showing the basic structure of the information reproducing apparatus in the example.

As shown in FIG. 1, an information reproducing apparatus 1 in the example is provided with a spindle motor 10, a pickup (PU) 11, a HPF (High Pass Filter) 12, an A/D converter 13, a pre-equalizer 14, a limit equalizer 15, a binary circuit 16, a decoding circuit 17, an offset calculation circuit 18, and an adder 19.

The pickup 11 photoelectrically converts reflected light when a laser beam LB is applied to a recording surface of an optical disc 100 rotated by the spindle motor 10, to thereby generate a read signal RR.

The HPF 12 removes a low-frequency component of the read signal R_{RF} outputted from the pickup, and it outputs a resulting read signal R_{HC} to the A/D converter 13.

The A/D converter 13 samples the read signal in accordance with a sampling clock outputted from a PLL (Phased Lock Loop) not illustrated or the like, and it outputs a resulting read sample value series RS to the pre-equalizer 14.

The pre-equalizer 14 removes intersymbol interference based on transmission characteristics in an information reading system, which is formed of the pickup 11 and the optical disc 100, and it outputs a resulting read sample value series RS_{C} to the limit equalizer 15 and the offset calculation circuit 18.

The offset calculation circuit 18 constitutes one specific example of the “adjusting device” of the present invention, and it calculates an offset value OFS which is to be added to the read sample value series RS_{C}, on the basis of the read sample value series RS_{C}. The calculated offset value OFS is added to the read sample value series RS_{C} on the adder 19. As a result, a read sample value series RS_{COFS} is generated.

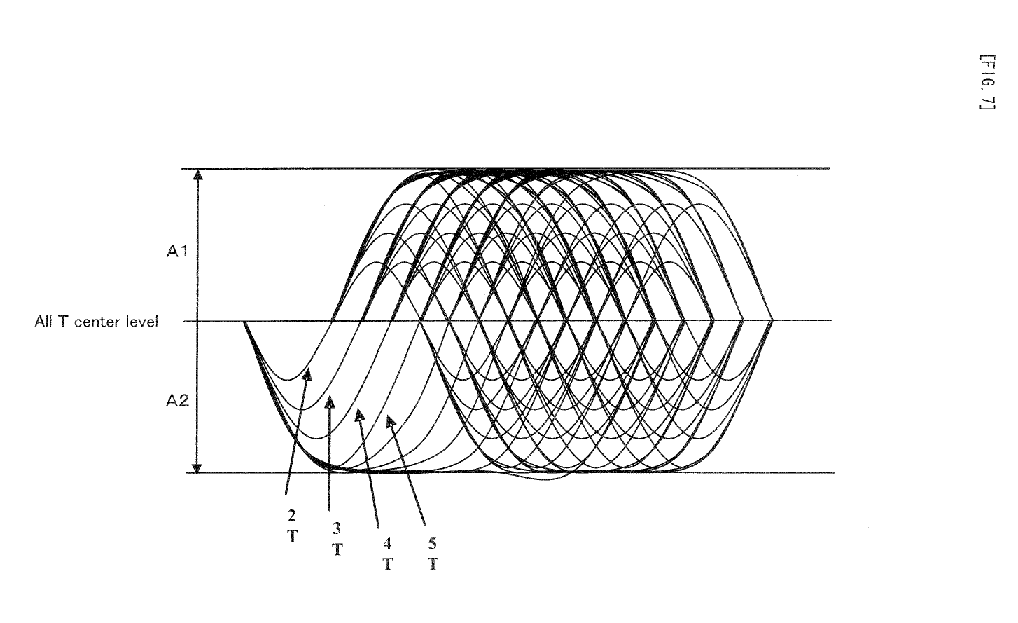

Incidentally, the offset value OFS calculated on the offset calculation circuit 18 is added to the read sample value series RS_{C} in order to adjust a zero level on the limit equalizer 15 (in other words, in order to change or set the zero level to a desired value). At this time, the appropriate offset value OFS is calculated on the offset calculation circuit 18 such that the zero level is located on the amplitude center of the read signal R_{RF} corresponding to a record mark with the shortest run length. Incidentally, an operation of calculating the offset value OFS will be detailed later (refer to FIG. 7 and subsequent drawings).

The limit equalizer 15 performs a high-frequency emphasis process on the read sample value series RS_{COFS} without increasing the intersymbol interference, and it outputs a resulting high-frequency emphasized read sample value series RS_{H} to the binary circuit 16.

The binary circuit 16 performs a binary process on the high-frequency emphasized read sample value series RS_{H}, and it outputs a resulting a binary signal to the decoding circuit 17.

The decoding circuit 17 performs a decoding process or the like on the binary signal, and it outputs a resulting reproduction signal to external reproduction equipment, such as a display and a speaker. As a result, the data recorded on the optical disc 100 (e.g. video data, audio data, and the like) is reproduced.

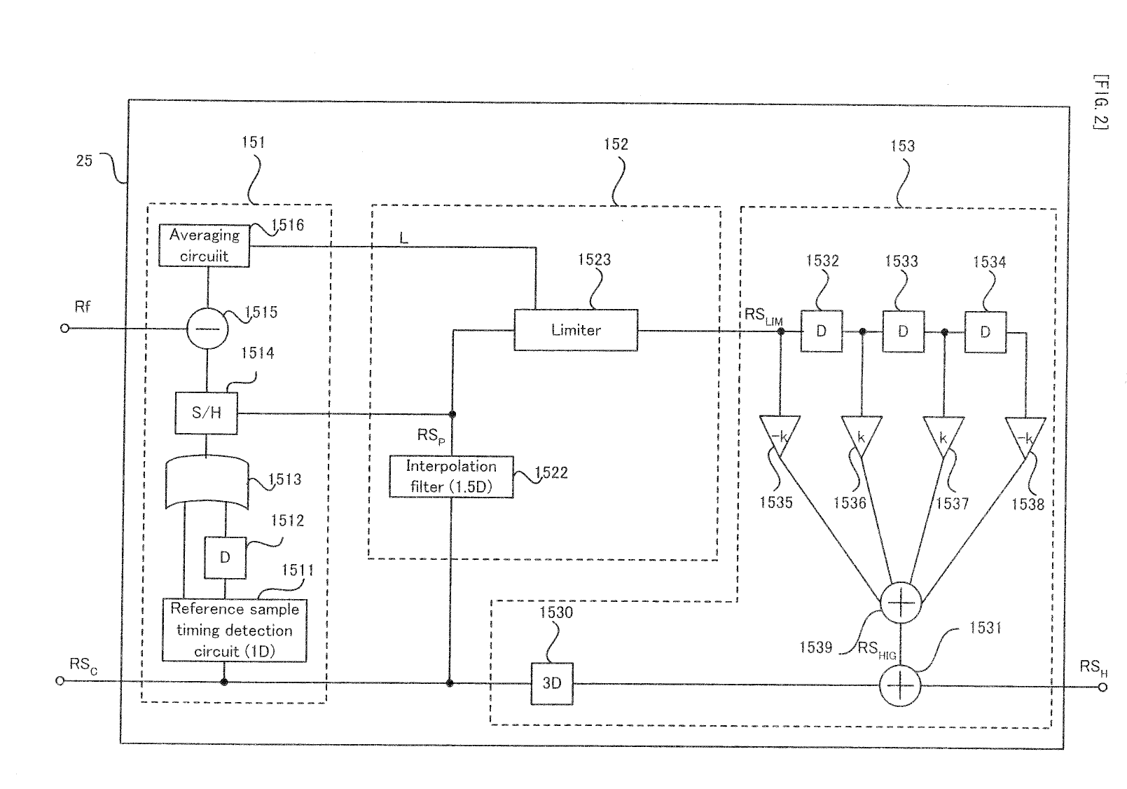

Next, with reference to FIG. 2, the detailed structure of the limit equalizer 15 will be explained. FIG. 2 is a block diagram conceptually showing the structure of the limit equalizer 15 in the example.

As shown in FIG. 2, the limit equalizer 15 is provided with an amplitude limit value setting block 151, which constitutes one specific example of the “amplitude limiting device” of the present invention; an amplitude limit block 152, which constitutes one specific example of the “amplitude limiting device” of the present invention; and a high-frequency emphasis block 153, which constitutes one specific example of the “filtering device” of the present invention.

The amplitude limit value setting block 151 sets the upper limit and the lower limit of an amplitude limit value used on the amplitude limit block 152, on the basis of the read sample value series RS_{C}. The amplitude limit block 152 performs an amplitude limit process on the read sample value series RS_{C}, on the basis of the upper limit and the lower limit of the amplitude limit value set on the amplitude limit value setting block 151. A sample value series RS_{LIM}, to which the amplitude limit process is performed is outputted to the high-frequency emphasis block 153. The high-frequency emphasis block 153 performs a filtering process for emphasizing high frequencies, on the sample value series RS_{LIM} to which the amplitude limit process is performed. As a result, the high-frequency emphasized read sample value series RS_{H} is obtained.

More specifically, a reference sample timing detection circuit 1511 detects reference sample timing, on the basis of the read sample value series RS_{C}. The detected reference sample timing is outputted to a sample hold circuit 1514 through a delayer 1512 for providing a one-clock delay and an OR circuit 1513. On the sample hold circuit 1514, a sample value series RS_{P} outputted from an interpolation filter 1522 is sampled and held in accordance with the reference sample timing outputted through the delayer 1512 and the OR circuit 1513.

Incidentally, the interpolation filter 1522 performs an interpolation process on the read sample value series RS_{C}, to thereby generate an interpolated sample value series which is obtained when the read signal R_{RF} read from the optical disc 100 is sampled in the middle timing of the clock timing by the sampling clock used on the A/D converter 14. The generated interpolated sample value series is included in the read sample value series RS_{C}, and it is outputted to the limiter 1523 and the sample hold circuit 1514 as the sample value series RS_{P}.

FROM the sample value series RS_{P} sampled and held, a reference level Rf is reduced on a subtractor 1515, wherein Rf=0 if a zero level is used as the reference level Rf. The subtraction result is outputted to an averaging circuit 1516. The averaging circuit 1516 calculates an average value of sample values. The calculated average value of sample values is set as the upper limit and the lower limit of the amplitude limit value. Specifically, a value obtained by adding the average value to the reference level is set as the upper limit of the amplitude limit value, and a value obtained by subtracting the average value from the reference level is set as the lower limit of the amplitude limit value. If the zero level is used as the reference level, a value obtained by providing a positive sign for the calculated average value of sample values is set as the upper limit of the amplitude limit value, and a value obtained by providing a negative sign for the calculated average value of sample values is set as the lower limit of the amplitude limit value. In the following explanation, for convenience of explanation, the zero level is used as the reference level Rf.

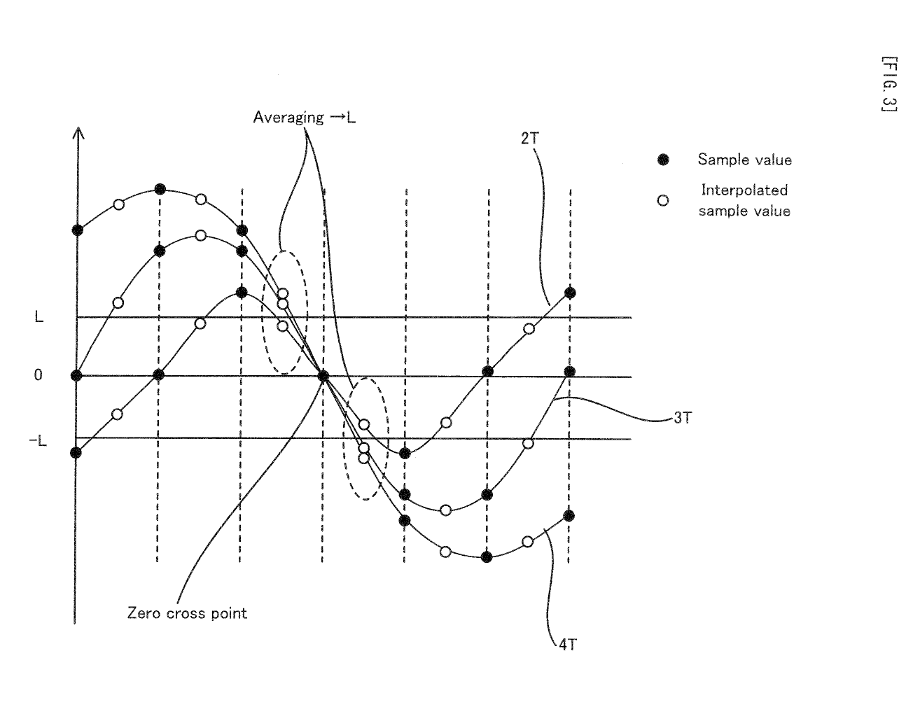

Specifically, with reference to FIG. 3, an explanation will be given on the upper limit and the lower limit of the amplitude limit value set on the amplitude limit value setting block 151. FIG. 3 is a waveform chart conceptually showing an operation of setting the upper limit and the lower limit of the amplitude limit value on the sample value series RS_{C}.

FIG. 3 shows the read signal R_{RF} obtained in reading data with a relatively short run length (specifically, data with run lengths of 2T, 3T, and 4T if the optical disc 100 is a Blu-ray Disc) of the read signal; and its sample value series RS_{C}. As shown in FIG. 3, an average value L of interpolated sample values (sample values generated on the interpolation filter 1522) located before (i.e. before in terms of time) a zero cross point and interpolated sample values located after (i.e. after in terms of time) the zero cross point is set as the absolute value of the upper value and the lower value of the amplitude limit value. In other words, the upper limit of the amplitude limit value is set as L, and the lower limit of the amplitude limit value is set as −L.

In FIG. 2 again, the limiter 1523 performs amplitude limit on the sample value series RS_{P} on the basis of the upper limit and the lower limit set on the amplitude limit value setting block 151. Specifically, if a sample value included in the sample value series RS_{P} is less than the upper limit L and greater than the lower limit −L, the sample value is outputted as the sample value series RS_{LIM} as it is. On the one hand, if a sample value included in the sample value series RS_{P} is greater than or equal to the upper limit L, the upper limit L is outputted as the sample value series RS_{LIM}. On the other hand, if a sample value included in the sample value series RS_{P} is less than or equal to the upper limit −L, the lower limit −L is outputted as the sample value series RS_{LIM}.

The high-frequency emphasis block 153 increases the signal level of only the sample value series RS_{LIM} corresponding to data with the shortest run length (e.g. the data with a run length of 3T if the optical disc 100 is a DVD, and the data with a run length of 2T if the optical disc 100 is a Blu-ray Disc) in the sample value series RS_{LIM}.

Specifically, the sample value series RS_{LIM} inputted to the high-frequency emphasis block 153 is inputted to coefficient multipliers 1535 and 1538 having a multiplier coefficient of −k and coefficient multipliers 1536 and 1537 having a multiplier coefficient of k, as it is or through delayers 1532, 1533, and 1534 for providing a one-clock delay The outputs of the coefficient multipliers 1535, 1536, 1537, and 1538 are added on an adder 1539. A high-frequency read sample value series RS_{HIG} which is an addition result is added to the read sample value series RS_{C} which is inputted to the adder 1531 through the delayer 1530 for providing a three-clock delay, on the adder 1531. As a result, the high-frequency emphasized read sample value series RS_{H} is obtained.

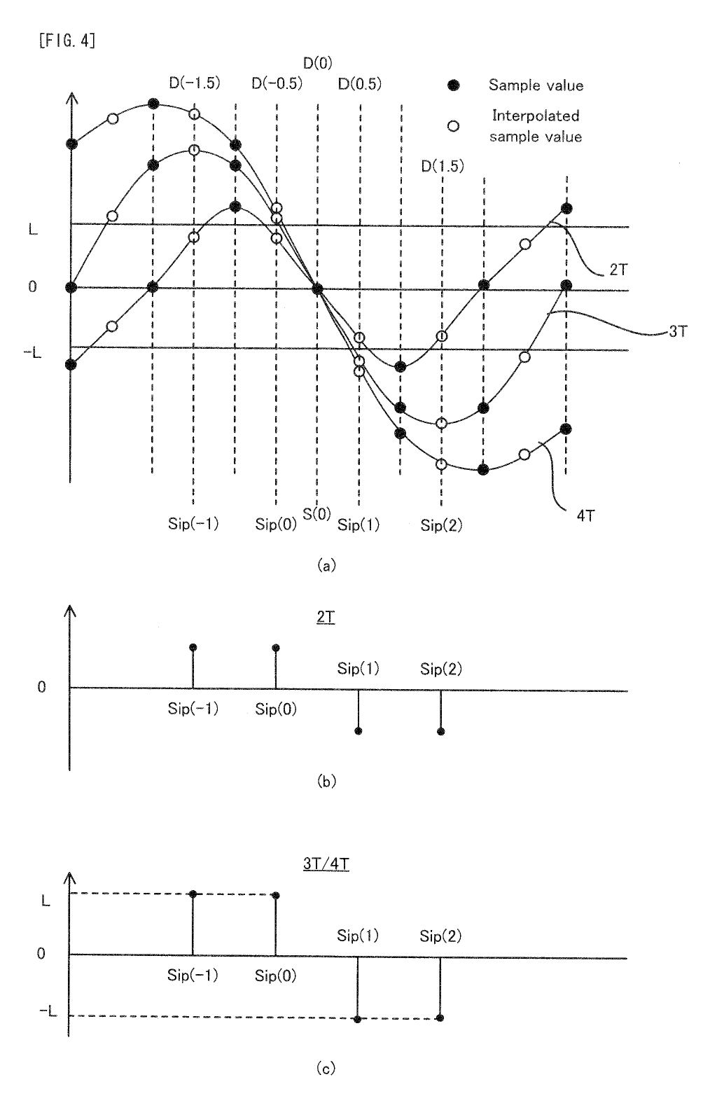

Now, with reference to FIG. 4, an operation of obtaining the high-frequency emphasized read sample value series RS_{H} is explained in more detail. FIG. 4 are waveform charts conceptually showing the operation of obtaining the high-frequency emphasized read sample value series RS_{H}, on the sample value series RS_{C}.

As shown in FIG. 4(a), the high-frequency read sample value series RS_{HIG} outputted from the adder 1531 is calculated on the basis of the sample values at respective time points D(−1.5), D(−0.5), D(0.5), and D(1.5) in the sample value series RS_{LIM}. Specifically, if the sample values at the respective time points D(−1.5), D(−0.5), D(0.5), and D(1.5) in the sample value series RS_{LIM} are set to Sip(−1), Sip(0), Sip(1), and Sip(2), then, RS_{HIG}=(−k)×Sip(−1)+k×Sip(0)+k×Sip(1)+(−k)×Sip (2).

At this time, as shown in FIG. 4(b), the sample values Sip(−1) and Sip(0) at the time points D(−1.5) and D(−0.5) corresponding to the data with a run length of 2T are substantially equal to each other. Moreover, the sample values Sip(1) and Sip(2) at the time points D(0.5) and D(1.5) corresponding to the data with a run length of 2T are substantially equal to each other.

Moreover, as shown in FIG. 4(c), the sample values Sip(−1) and Sip(0) at the time points D(−1.5) and D(−0.5) corresponding to the data with each of run lengths of 3T and 4T are both the upper limit L of the amplitude limit value, due to the amplitude limit by the amplitude limit block 152. In the same manner, the sample values Sip(1) and Sip(2) at the time points D(0.5) and D(1.5) corresponding to the data with each of run lengths of 3T and 4T are both the lower limit −L of the amplitude limit value, due to the amplitude limit by the amplitude limit block 152. In other words, the dispersion of the sample values before and after the reference sample point is forcibly controlled.

Thus, even if the value of the coefficient k is increased on the coefficient multipliers 1535, 1536, 1537, and 1538 in order to increase the high-frequency emphasis, the high-frequency read sample value series RS_{HIG} obtained at the zero cross point D(0) is kept constant. Therefore, the intersymbol interference does not occur.

As explained above, according to the information reproducing apparatus 1 in the example, the dispersion of the sample values before and after the zero cross point in the read signal, which causes the intersymbol interference, is forcibly controlled in the high-frequency emphasis. Thus, even if the sufficient high-frequency emphasis is performed on the high-frequency emphasis block 153, the intersymbol interference does not occur.

In particular, according to the information reproducing apparatus 1 in the example, the zero level can be adjusted by adding the offset value OFS to the read sample value series RS_{C}. Thus, even if there is asymmetry, even if a value is not zero, even if there is waveform distortion, or in similar cases, it is possible to preferably perform amplitude limit and high-frequency emphasis while eliminating influences due to the asymmetry, the value, and the waveform distortion.

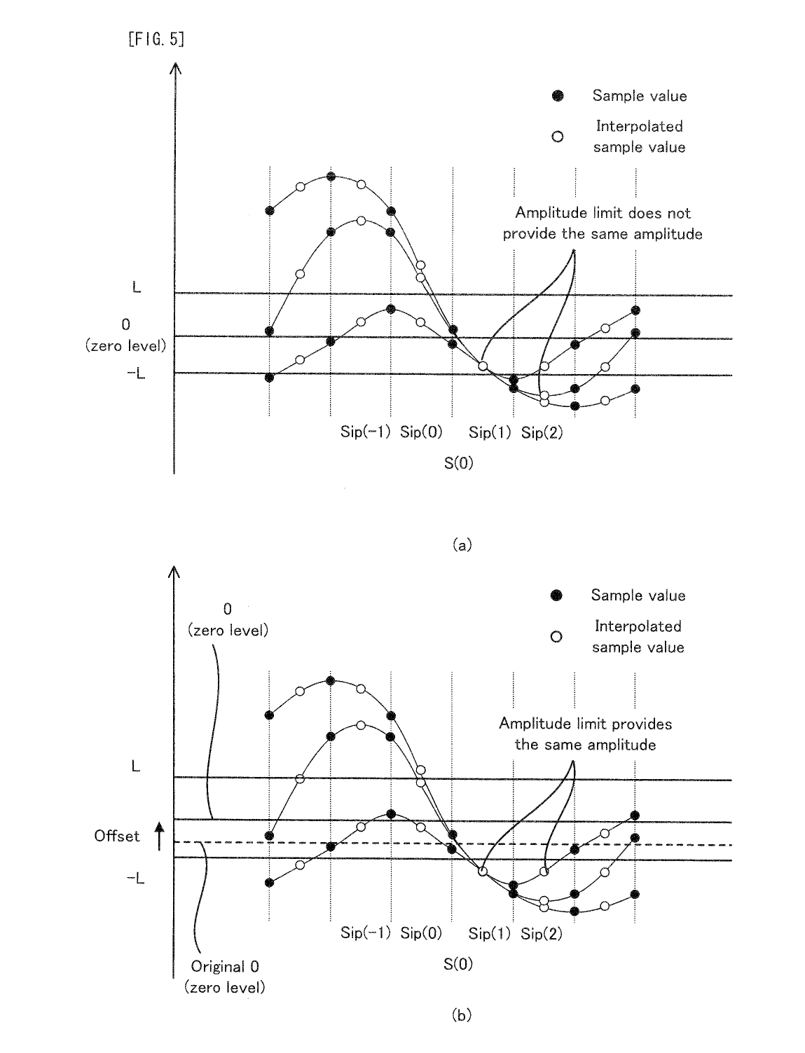

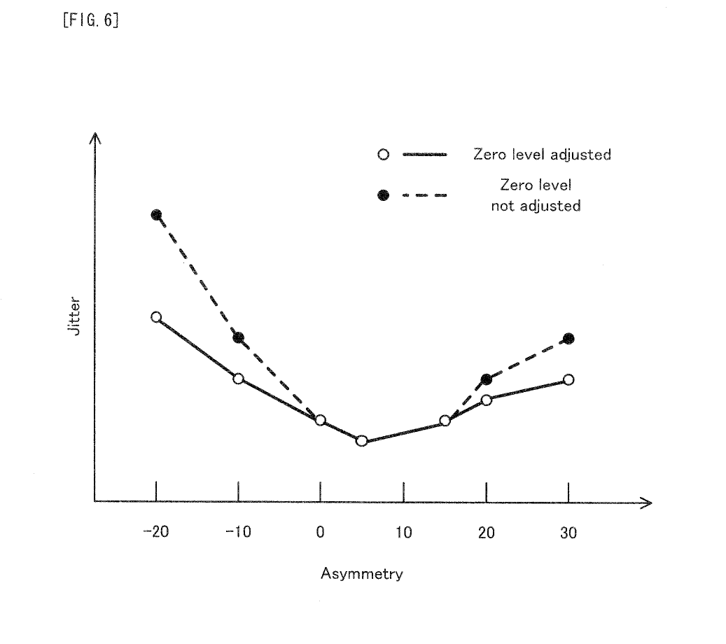

This effect will be explained in more detail, with reference to FIG. 5 and FIG. 6. FIG. 5 are waveform charts conceptually showing the sample value series RS_{C} and the zero level if there is the asymmetry. FIG. 6 is a graph conceptually showing a correlation between the asymmetry and a jitter value.

As shown in FIG. 5(a), it is assumed that the asymmetry occurs in the read signal R_{RF}. Specifically, it is assumed that the asymmetry occurs such that the amplitude center of the read signal R_{RF} corresponding to the record mark with the shortest run length is less than the zero level. If the zero level is set without adding the offset value OFS to the read sample value series RS_{C}, the zero level is set as the value of the read signal R_{RF} (i.e. an average position of the amplitude center of the read signal R_{RF}). Thus, the zero level deviates from the amplitude center of the read signal R_{RF} corresponding to the record mark with a run length of 2T. Moreover, the sample value Sip(1) and the sample value Sip(2) do not have the same value even if the amplitude limit is performed, which results in the intersymbol interference.

On the other hand, as shown in FIG. 5(b), for example, adding the offset value OFS, which shifts the zero level in a positive direction, to the read sample value series RS_{C} further increases the deviation between the zero level and the amplitude center of the read signal R_{RF} corresponding to the record mark with a run length of 2T; however, the sample value Sip(1) and the sample value Sip(2) have the same value. By this, the high-frequency emphasis can be performed on the limit equalizer 15 without deteriorating the reproduction features.

The effect of the information reproducing apparatus 1 in the example can be seen from a jitter value. As shown in FIG. 6, it can be seen the jitter is improved if the offset value OFS is added to the zero level (i.e. if the zero level is adjusted), compared to a case where the zero level is uniquely fixed (i.e. if the zero level is not adjusted). In other words, by adding the offset value OFS to the zero level, it is possible to increase an allowable margin to the asymmetry

As described above, according to the information reproducing apparatus 1 in the example, it is possible to more preferably perform the high-frequency emphasis, compared to the technology disclosed in the aforementioned background (i.e. the technology that the zero level is set without adding the offset value OFS to the read sample value series RS_{C}, and more specifically, the value zero level of the read signal R_{RF} is fixedly set).

### (2) Operation of Calculating Offset Value OFS

Next, with reference to FIG. 7 to FIG. 21, an operation of calculating the offset value OFS will be explained.

### (2-1) Calculation of Offset Value OFS Based On Value

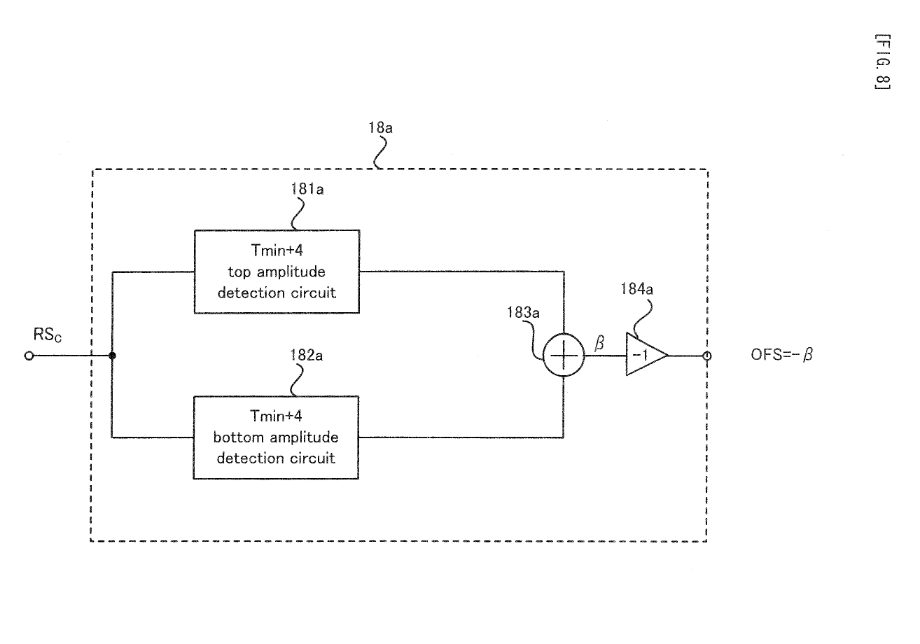

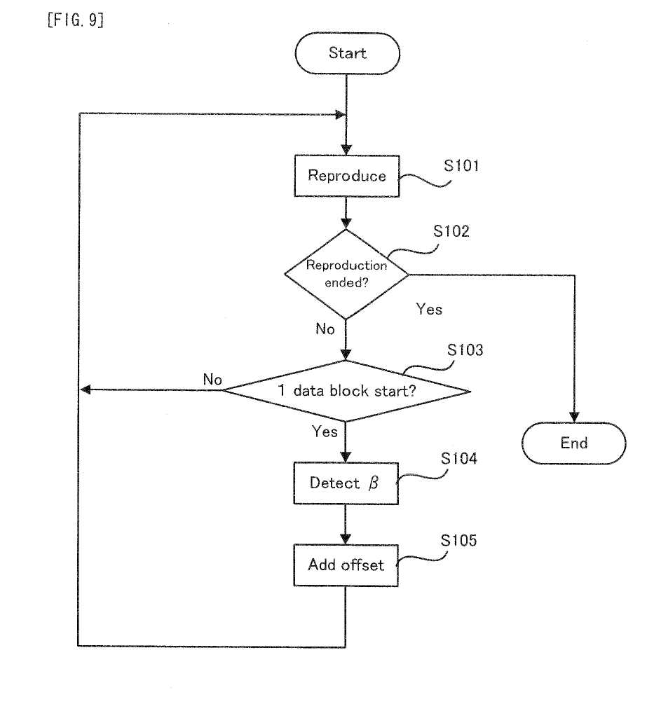

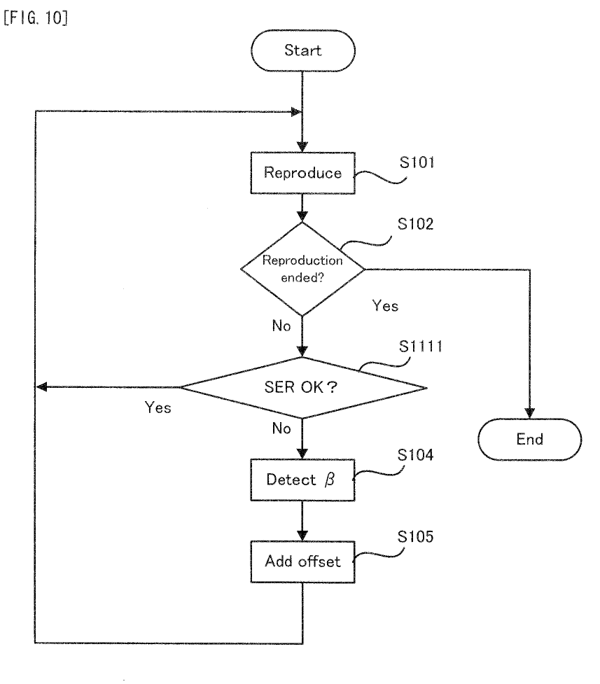

Firstly, with reference to FIG. 7 to FIG. 10, an explanation will be explained on the operation of calculating the offset value OFS based on the value. FIG. 7 is a waveform chart conceptually showing the value, FIG. 8 is a block diagram conceptually showing an offset calculation circuit 18a for calculating the offset value OFS based on the value. FIG. 9 is a flowchart conceptually showing a flow of one operation of the information reproducing apparatus 1 in the example when the offset value OFS based on the value is calculated. FIG. 10 is a flowchart conceptually showing a flow of another operation of the information reproducing apparatus 1 in the example when the offset value OFS based on the value is calculated.

As shown in FIG. 7, the value indicates the average position of the amplitude center of the read signals R_{RF} corresponding to the respective record data with all types of run lengths (e.g. the record data with each of run lengths of 3T to 11T and 14T if the optical disc 100 is a DVD, and the record data with each of run lengths of 2T to 9T if the optical disc 100 is a Blu-ray Disc). Specifically, =(A1+A2)/(A1−A2), wherein A1 is the magnitude of the maximum amplitude (top amplitude) on the upper side (positive side) which is based on the amplitude center (i.e. all T center level) of the read signals R_{RF} corresponding to the record data with all types of run lengths (i.e. the amplitude center is set at the origin or base point) and A2 is the magnitude of the maximum amplitude (bottom amplitude) on the lower side (negative side) which is based on the amplitude center of the read signals R_{RF} corresponding to the record data with all types of run lengths.

As shown in FIG. 8, the offset calculation circuit 18a is provided with a Tmin+4 top amplitude detection circuit 181a, a Tmin+4 bottom amplitude detection circuit 182a, an adder 183a, and an amplifier 184a. The sum of the top amplitude detected on the Tmin+4 top amplitude detection circuit 181a and the bottom amplitude detected on the Tmin+4 bottom amplitude detection circuit 182a is added on the adder 183a. The output of the adder 183a is the value. Then, the offset value OFS actually outputted to the limiter 1523 is the value which is not normalized by entire amplitudes (i.e. −) and which is amplified by −1 time on the amplifier 184a.

Incidentally, Tmin denotes the read signal R_{RF} (more specifically, the read sample value series RS_{C} corresponding to the read signal R_{RF}) corresponding to the record data with the shortest run length. Therefore, Tmin+4 denotes the read signal R_{RF} corresponding to the record data with the fifth shortest run length. For example, if the optical disc 100 is a DVD, Tmin+4 denotes the read signal R_{RF} corresponding to the record data with a run length of 7T. For example, if the optical disc 100 is a Blu-ray Disc, Tmin+4 denotes the read signal R_{RF} corresponding to the record data with a run length of 6T.

Here, Tmin+4 is used in order to simply show all the run lengths (i.e. for convenience of calculation). Thus, obviously, the same process (i.e. process of calculating the sum of the top amplitude and the bottom amplitude) may be performed on all T and their average value may be set as the value.

The offset value OFS calculated in this manner may be added as needed during the reproduction operation. Specifically, as shown in FIG. 9, when the reproduction operation is performed (step S101), it is judged whether or not the reproduction operation is to be ended as occasion demands (step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not the reproduction for one data block is newly started (step S103).

As a result of the judgment in the step S103, if it is judged that the reproduction for one data block is not newly started (i.e. that the past reproduction for the data block is continued) (the step S103: No), the operational flow returns to the step S101, and the reproduction operation is continued.

On the other hand, as a result of the judgment in the step S103, if it is judged that the reproduction for one data block is newly started (the step S103: Yes), then, the value is calculated by the operation of the offset calculation circuit 18a (step S104). Then, the ofset value OFS corresponding to the value is added to the read sample value series RS_{C} (step S105).

Alternatively, the offset value OFS may be added if there is a reproduction error in the reproduction operation. Specifically, as shown in FIG. 10, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not a value of SER (Symbol Error Rate) is normal (step S111).

As a result of the judgment in the step S111, if it is judged that the value of SER is normal (the step S111: Yes), the operational flow returns to the step S101, and the reproduction operation is continued.

On the other hand, as a result of the judgment in the step S111, if it is judged that the value of SER is not normal (the step S111: No), then, the value is calculated by the operation of the offset calculation circuit 18a (the step S104). Then, the offset value OFS corresponding to the value is added to the read sample value series RS_{C} (the step S105).

As described above, by adding the offset value OFS corresponding to the value to the read sample value series RS_{C}, it is possible to receive the aforementioned various effects while eliminating the influence due to the value (i.e. the influence due to the deviation of the amplitude center).

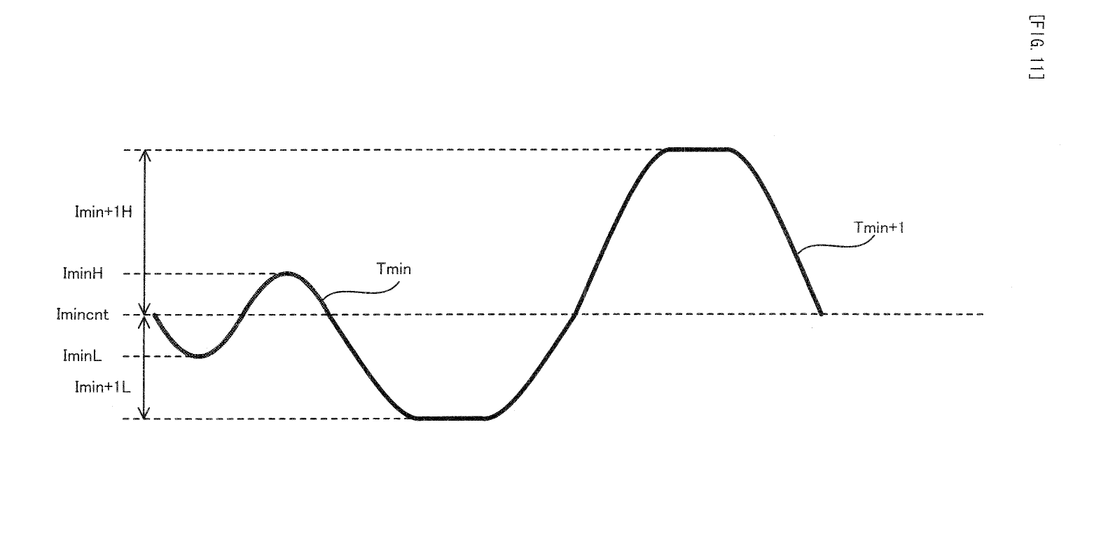

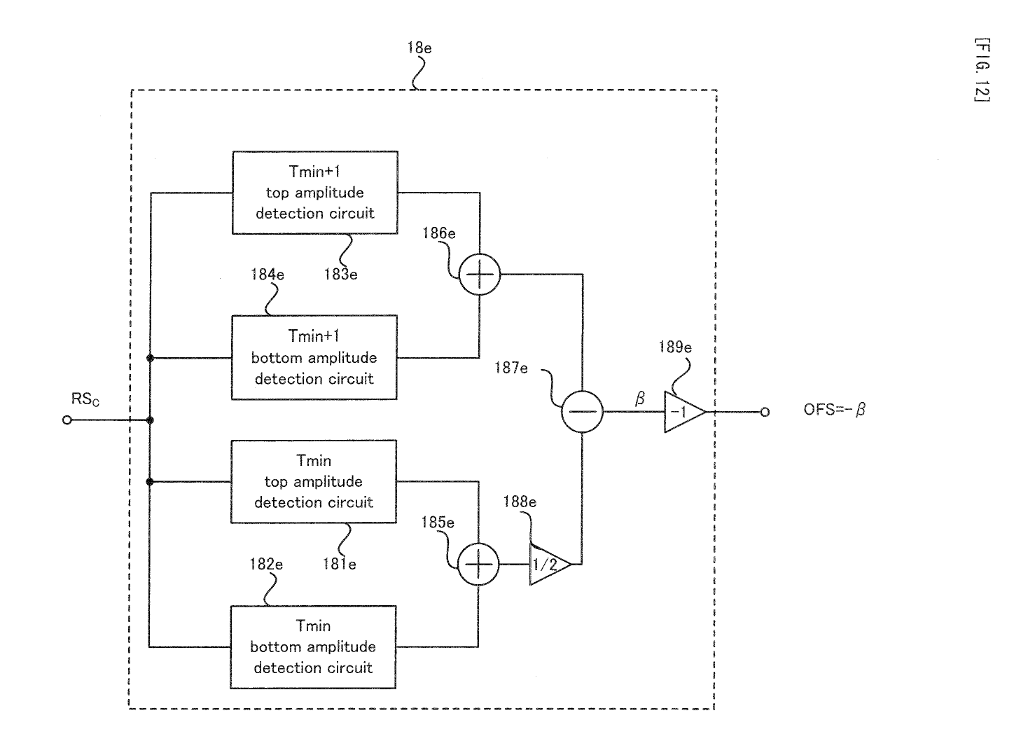

Moreover, offset values OFS1 and OFS2 may be calculated on the basis of another value obtained from a different viewpoint from the value shown in FIG. 7. This construction will be explained with reference to FIG. 11 and FIG. 12. FIG. 11 is a waveform chart conceptually showing another value. FIG. 12 is a block diagram conceptually showing an offset calculation block 154b for calculating an offset value based on another value.

As shown in FIG. 11, another value indicates the deviation between the amplitude center of the read signals R_{RF} corresponding to the record data with the shortest run length and the amplitude center of the read signals R_{RF} corresponding to the record data with the second shortest run length. Specifically, another value=(Imin+1H+Imin+1L)/(Imin+1H-Imin+1L), wherein the amplitude center of the read signal corresponding to the record data with the shortest run length is IminCnt, Imin+1H indicates the magnitude of the top amplitude of the read signal R_{RF} corresponding to the record data with the second shortest run length based on IminCnt, and Imin+1L indicates the magnitude of the bottom amplitude of the read signal R_{RF} corresponding to the record data with the second shortest run length based on IminCnt. Incidentally, IminCnt is an average value of the top amplitude value IminH and the bottom amplitude value IminL of the read signal R_{RF} corresponding to the record data with the shortest run length.

As shown in FIG. 12, an offset calculation circuit 18e is provided with a Tmin top amplitude detection circuit 181e, a Tmin bottom amplitude detection circuit 182e, a Tmin+1 top amplitude detection circuit 183e, a Tmin+1 bottom amplitude detection circuit 184e, adders 185e and 186e, a subtractor 187e, an amplifier 188e, and an amplifier 189e. A difference is calculated on the subtractor 187e wherein the difference is between the sum of the top amplitude detected on the Tmin top amplitude detection circuit 181e and the bottom amplitude detected on the Tmin bottom amplitude detection circuit 182e; and a value obtained by amplifying the sum of the top amplitude detected on the Tmin+1 top amplitude detection circuit 183e and the bottom amplitude detected on the Tmin+1 bottom amplitude detection circuit 184e by ½ on the amplifier 188e. The output of the subtractor 187e is another value that is not normalized by the amplitude of Tmin+1. Then, another value (i.e. −) amplified by −1 time on the amplifier 189a is the offset value OFS actually outputted to the limiter 1523.

### (2-2) Calculation of Offset Value OFS Based On Asymmetry Value

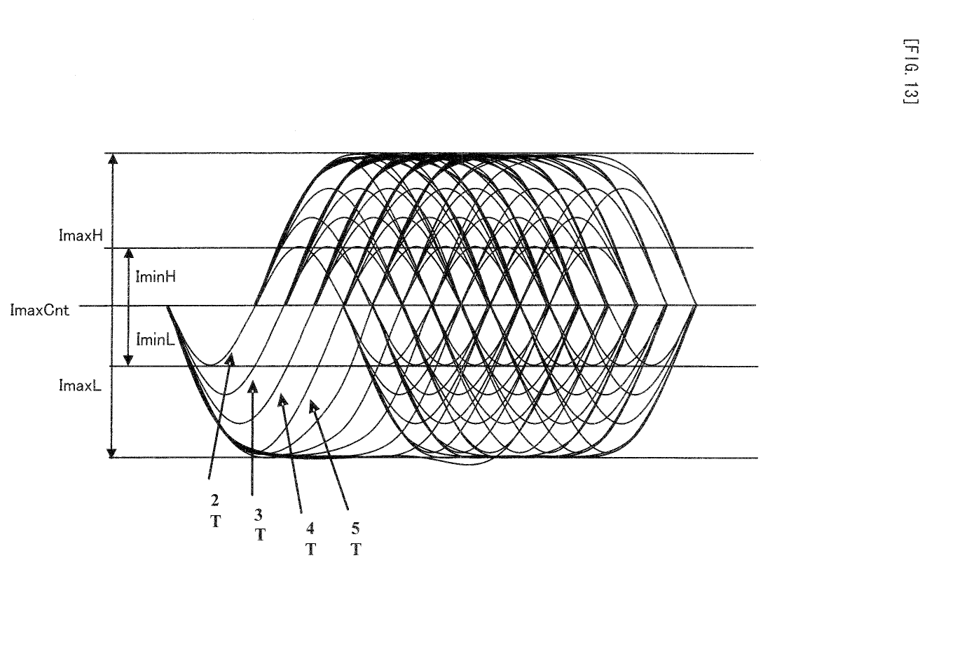

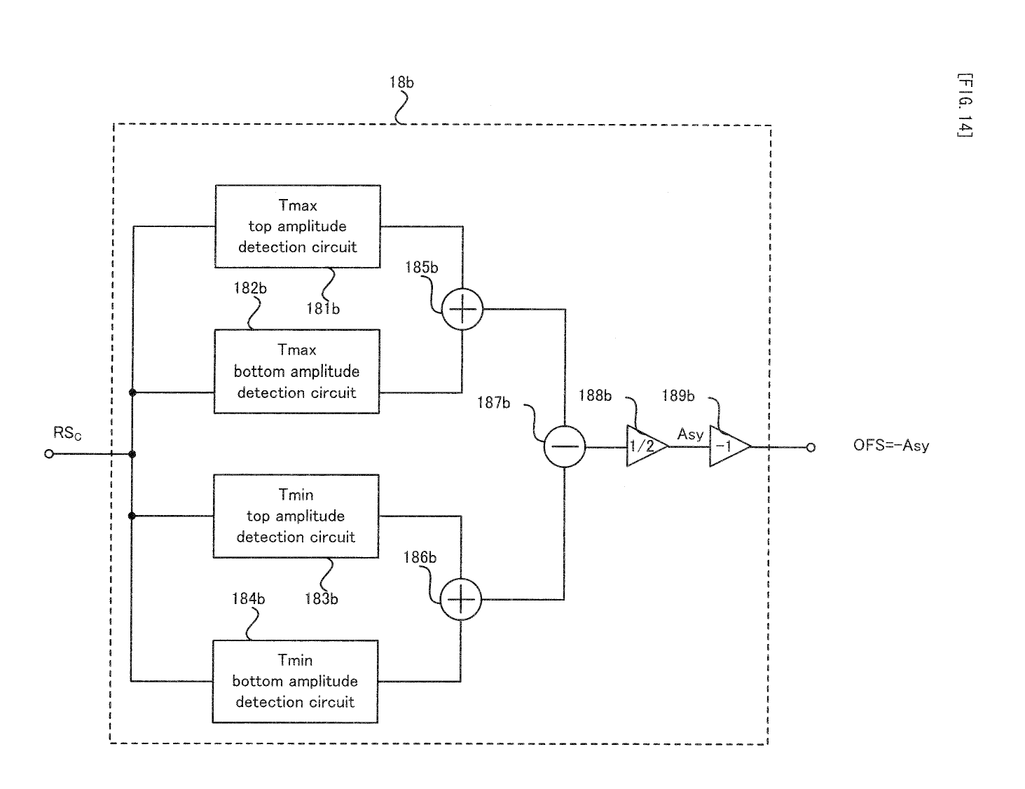

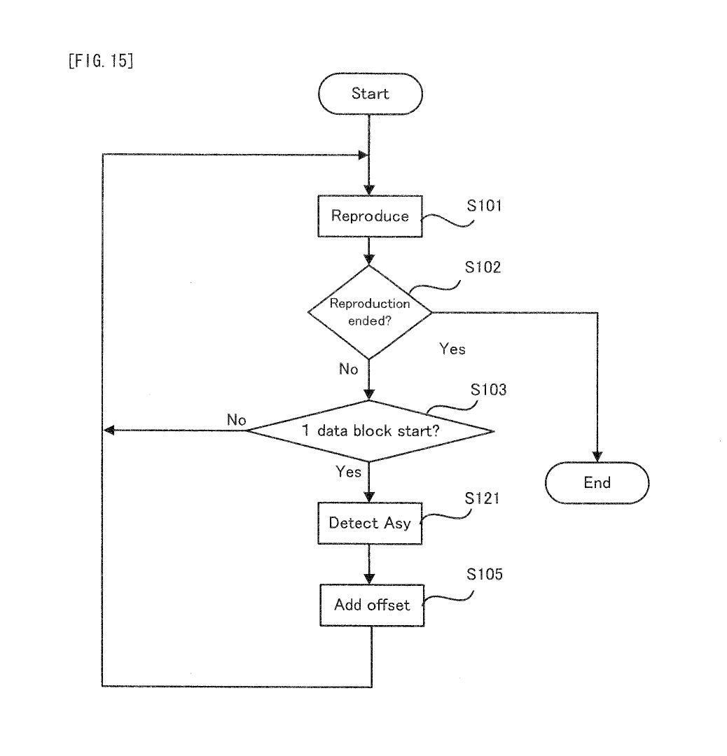

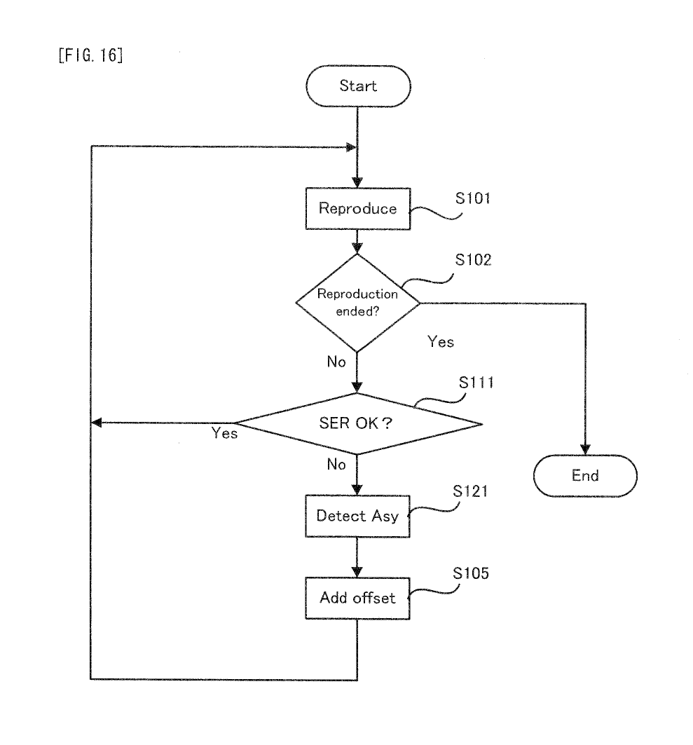

Next, with reference to FIG. 13 to FIG. 16, an explanation will be explained on the operation of calculating the offset value OFS based on the asymmetry value. FIG. 13 is a waveform chart conceptually showing an asymmetry value. FIG. 14 is a block diagram conceptually showing an offset calculation circuit 18b for calculating an offset value OFS based on the asymmetry value. FIG. 15 is a flowchart conceptually showing a flow of one operation of the information reproducing apparatus 1 in the example when the offset value OFS based on the asymmetry value is calculated. FIG. 16 is a flowchart conceptually showing a flow of another operation of the information reproducing apparatus 1 in the example when the offset value OFS based on the asymmetry value is calculated.

As shown in FIG. 13, the asymmetry value indicates the deviation of the amplitude center of the read signal corresponding to the record data with the shortest run length, with respect to the amplitude center of the read signal R_{RF} corresponding to the record data with the longest run length. Specifically, the asymmetry value Asy=((ImaxH+ImaxL)−(IminH+IminL))/(2×(ImaxH−ImaxL)), wherein the amplitude center of the read signal R_{RF} corresponding to the data with the longest run length is ImaxCnt, ImaxH is the magnitude of the top amplitude of the read signal R_{RF} corresponding to the data with the longest run length based on ImaxCnt, ImaxL is the magnitude of the bottom amplitude of the read signal R_{RF} corresponding to the data with the longest run length based on ImaxCnt, IminH is the magnitude of the top amplitude of the read signal R_{RF} corresponding to the data with the shortest run length based on ImaxCnt, and IminL is the magnitude of the bottom amplitude of the read signal R_{RF} corresponding to the data with the shortest run length based on ImaxCnt. Incidentally, ImaxCnt is an average value of the top amplitude value and the bottom amplitude value of the read signal R_{RF} corresponding to the data with the longest run length.

As shown in FIG. 14, the offset calculation circuit 18b is provided with a Tmax top amplitude detection circuit 181b, a Tmax bottom amplitude detection circuit 182b, a Tmin top amplitude detection circuit 183b, a Tmin bottom amplitude detection circuit 184b, adders 185b and 186b, a subtractor 187b, an amplifier 188b, and an amplifier 189b. A difference is calculated on the subtractor 187b wherein the difference is between the sum of the top amplitude detected on the Tmax top amplitude detection circuit 181b and the bottom amplitude detected on the Tmax bottom amplitude detection circuit 182b; and the sum of the top amplitude detected on the Tmin top amplitude detection circuit 183b and the bottom amplitude detected on the Tmin bottom amplitude detection circuit 184b. At the same time, the output of the subtractor 187b is halved on the amplifier 188b. The output of the amplifier 188c is the asymmetry value Asy. Then, the offset value OFS actually outputted to the limiter 1523 is the asymmetry value Asy (i.e. −Asy) amplified by −1 time on the amplifier 189b.

Incidentally, Tmax denotes the read signal R_{RF} corresponding to the record data with the longest run length (more specifically, the read sample value series RS_{C} corresponding to the read signal R_{RF}). For example, if the optical disc 100 is a DVD, Tmax denotes the read signal R_{RF} corresponding to the record data with a run length of 11T. For example, if the optical disc 100 is a Blu-ray Disc, Tmax denotes the read signal R_{RF} corresponding to the record data with a run length of 8T.

The offset value OFS calculated in this manner may be added as needed during the reproduction operation. Specifically, as shown in FIG. 15, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not the reproduction for one data block is newly started (the step S103).

As a result of the judgment in the step S103, if it is judged that the reproduction for one data block is not newly started (i.e. that the past reproduction for the data block is continued) (the step S103: No), the operational flow returns to the step S101, and the reproduction operation is continued.

On the other hand, as a result of the judgment in the step S103, if it is judged that the reproduction for one data block is newly started (the step S103: Yes), then, the asymmetry value Asy is calculated by the operation of the offset calculation circuit 18b (step S121). Then, the offset value OFS corresponding to the asymmetry value is added to the read sample value series RS_{C} (the step S105).

Alternatively, the offset value OFS may be added if there is a reproduction error in the reproduction operation. Specifically, as shown in FIG. 10, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not a value of SER (Symbol Error Rate) is normal (the step S111).

As a result of the judgment in the step S111, if it is judged that the value of SER is normal (the step S111: Yes), the operational flow returns to the step S101, and the reproduction operation is continued.

On the other hand, as a result of the judgment in the step S111, if it is judged that the value of SER is not normal (the step S111: No), then, the asymmetry value Asy is calculated by the operation of an offset calculation circuit 154c (step S121). Then, the offset value OFS corresponding to the asymmetry value is added to the read sample value series RS_{C} (the step S105).

As described above, by adding the offset value OFS corresponding to the asymmetry value Asy to the read sample value series RS_{C}, it is possible to receive the aforementioned various effects while eliminating the influence due to the asymmetry value Asy (i.e. the influence due to the deviation of the amplitude center).

### (2-3) Calculation of Offset Value OFS Based On Waveform Distortion Amount

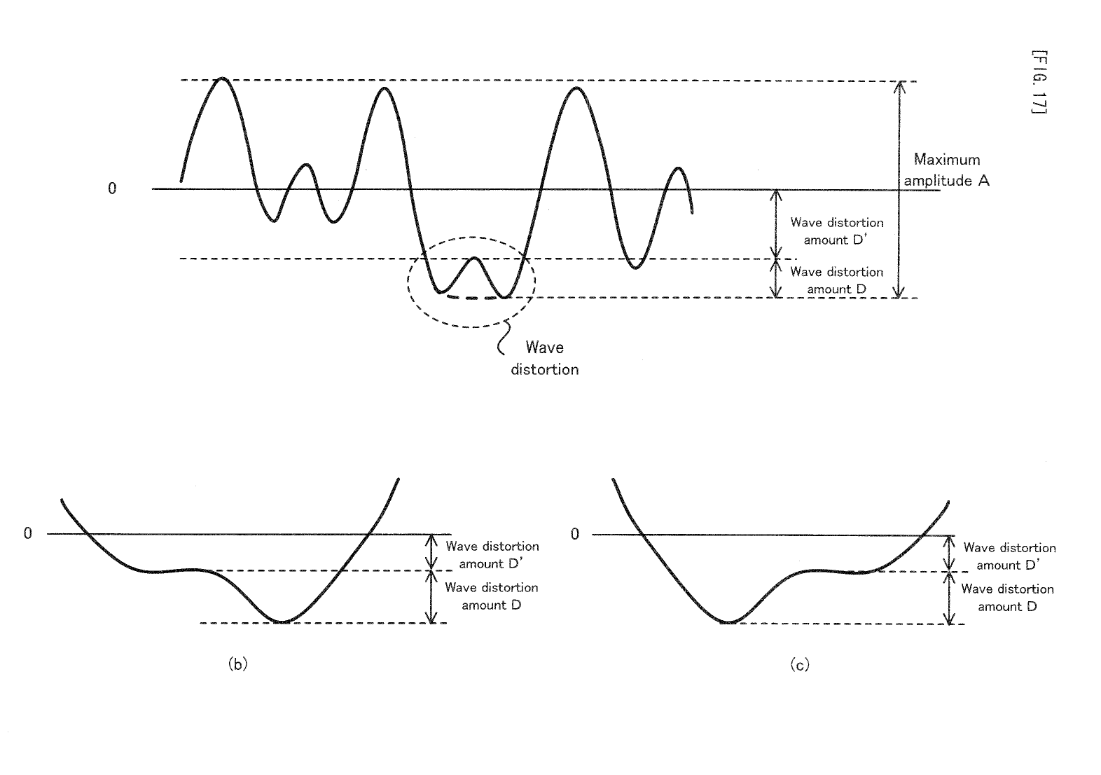

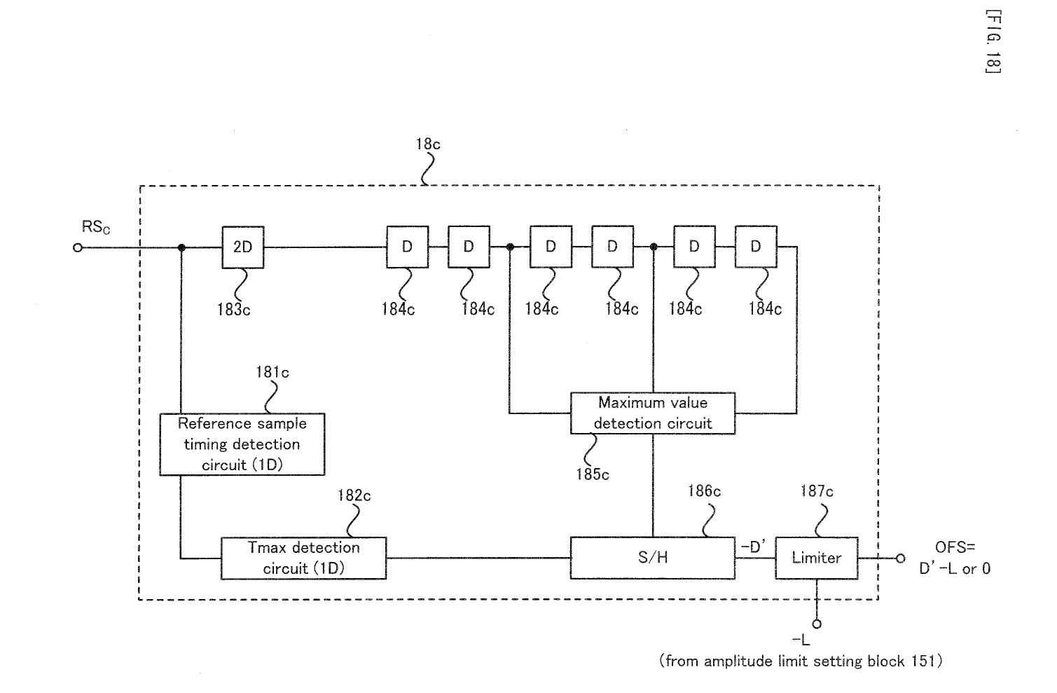

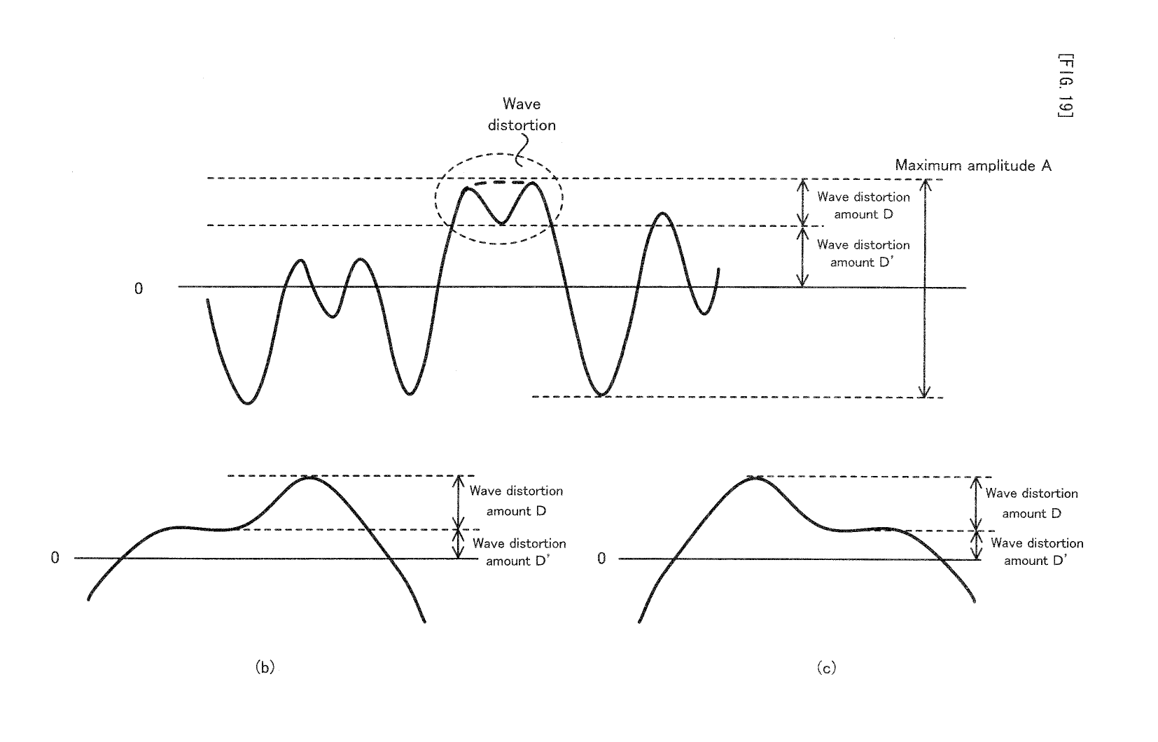

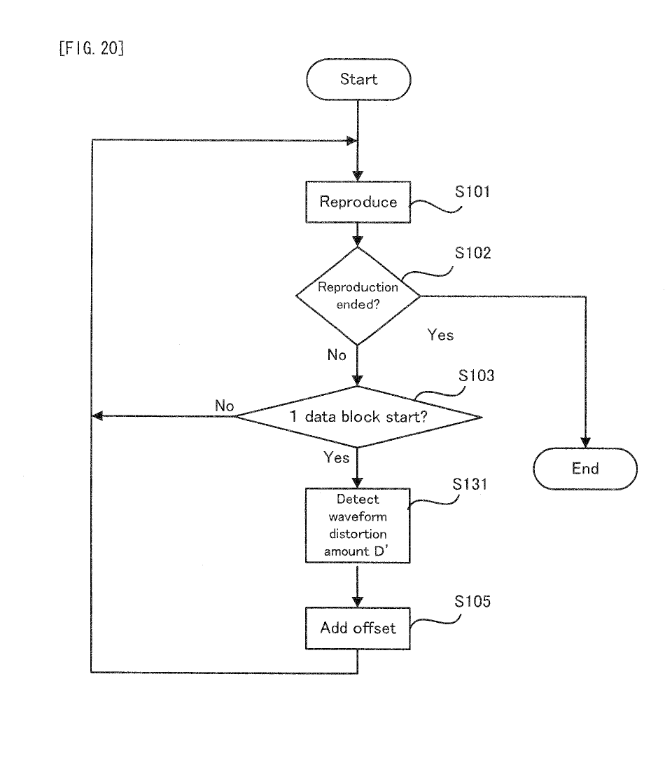

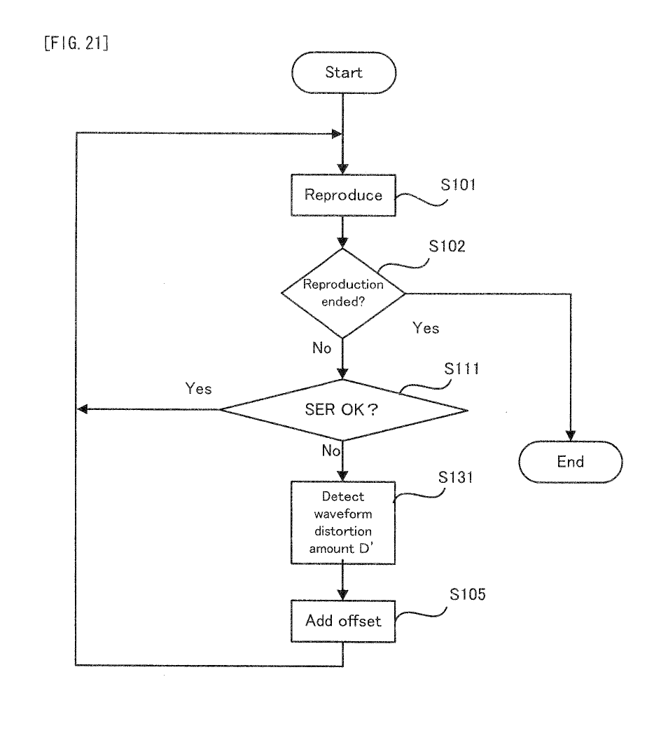

Next, with reference to FIG. 17 to FIG. 21, an explanation will be explained on the operation of calculating an offset value OFS based on the waveform distortion amount. FIG. 17 is a waveform chart conceptually showing waveform distortion. FIG. 18 is a block diagram conceptually showing an offset calculation circuit 18c for calculating the offset value OFS based on the waveform distortion. FIG. 19 is a waveform chart conceptually showing another waveform distortion. FIG. 20 is a flowchart conceptually showing a flow of one operation of the information reproducing apparatus 1 in the example when the offset value OFS based on the waveform distortion is calculated. FIG. 21 is a flowchart conceptually showing a flow of another operation of the information reproducing apparatus 1 in the example when the offset value OFS based on the waveform distortion is calculated.

As shown in FIG. 17(a), the waveform distortion indicates a difference between a proper signal level and a signal level that actually appears in the read signal R_{RF}. The waveform distortion is quantitatively defined by a waveform distortion amount D with respect to the maximum amplitude A of the read signal R_{RF}, and a waveform distortion amount D′ which is a signal level from the zero level to the peak of the waveform distortion. In FIG. 17(a), a thick dashed line indicates the proper signal level when there is no waveform distortion. If there is no waveform distortion, the waveform distortion amount D is obviously zero.

Incidentally, the waveform distortion shown in FIG. 17(a) indicates the waveform distortion that the signal level in a middle portion is changed, compared to the signal level in a front edge portion and a rear edge portion of the read signal R_{RF}. Apart from such waveform distortion, there can be the waveform distortion that the signal level in the front edge portion and the middle portion is changed, compared to the signal level in the rear edge portion of the read signal R_{RF} as shown in FIG. 17(b); and the waveform distortion that the signal level in the middle edge portion and the rear portion is changed, compared to the signal level in the front edge portion of the read signal R_{RF} as shown in FIG. 17(c). For any waveform distortion, the structure and operation described later can be obviously adopted.

Moreover, in the example, it is preferable to focus on the waveform distortion which occurs in the read signal corresponding to the record mark with a relatively long run length (e.g. data with a run length of 11T if the optical disc 100 is a DVD, and data with a run length of 8T if the optical disc 100 is a Blu-ray Disc).

As shown in FIG. 18, the offset calculation circuit 18c is provided with a reference sample timing detection circuit 181c, a Tmax detection circuit 182c, a delay circuit 183c for providing a two-clock delay, a plurality of delay circuits 184c each of which provides a one-clock delay, a maximum value detection circuit 185c, a sample hold circuit 186c, and a limiter 187c.

The read sample value series RS_{C} inputted to the offset calculation circuit 18c is outputted to each of the reference sample timing detection circuit 181c and the delay circuit 183c. On the reference sample timing detection circuit 181c, reference sample timing is detected on the basis of the read sample value series RS_{C}. The detected reference sample timing is used for an operation of detecting Tmax (specifically, an operation of detecting the sample value corresponding to Tmax) on the Tmax detection circuit 182c. Tmax detected on the Tmax detection circuit 182c is outputted to the sample hold circuit 186c. On the other hand, a two-clock delay is provided to the read sample value series R_{SC} on the delay circuit 183c. Then, the read sample value series R_{SC} is outputted to the maximum value detection circuit 185c by the operations of the delay circuits 184c every time a two-clock delay is provided. In other words, the signal level in the front edge portion, the signal level in the middle portion, and signal level in the rear edge portion shown in FIG. 17 are outputted to the maximum detection circuit 185c. Therefore, the maximum signal level (i.e. the waveform distortion amount D′ shown in FIG. 17) of the signal level in the front edge portion, the signal level in the middle portion, and signal level in the rear edge portion is outputted from the maximum detection circuit 185c. Incidentally, in the example of the waveform distortion shown in FIG. 17, since the waveform distortion occurs at the zero level or less, the outputted waveform distortion amount is −D′. Then, on the sample hold circuit 186c, Tmax detected on the Tmax detection circuit 182c is sampled and held by the output of the maximum detection circuit 185c, and as a result, the waveform distortion amount D′ is obtained. The waveform distortion amount D′ obtained in this case is used in the calculation of the offset value OFS outputted to the limiter 1523. The offset value actually outputted to the limiter 1523 is D′−L if D′>−L and it is zero if −D′. −L, by the limiter 187c which performs level limit according to the lower limit −L of the amplitude limit value outputted from the amplitude limit value setting block 151.

Incidentally, here, an explanation was given on the operation aimed at the optical disc 100 in which the reflectance of the laser beam LB is reduced by recording the record data. In other words, an explanation was given on the operation aimed at the case where the waveform distortion occurs such that the signal level unintentionally increases, in the signal level which is the zero level or less. However, the operation may be aimed at the optical disc 100 in which the reflectance of the laser beam LB is increased by recording the record data. In other words, as shown in FIG. 19(a) to FIG. 19(c), it may be aimed at the case where the waveform distortion occurs such that the signal level unintentionally reduces, in the signal level which is the zero level or more. In this case, the maximum detection circuit 185c in the offset calculation circuit 18c shown in FIG. 18 is replaced by a minimum value detection circuit 187c, and the limiter 187c perform level limit according to the upper limit L of the amplitude limit value outputted from the amplitude limit value setting block 151. The offset value OFS actually outputted to the limiter 1523 is L−D′ if D′<L and it is zero if D′L, by the limiter 187c which performs the level limit according to the upper limit L of the amplitude limit value outputted from the amplitude limit value setting block 151.

The offset value OFS calculated in this manner may be added as needed during the reproduction operation. Specifically, as shown in FIG. 20, when the reproduction operation is performed (the step S110), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not the reproduction for one data block is newly started (the step S103).

As a result of the judgment in the step S103, if it is judged that the reproduction for one data block is not newly started (i.e. if it is judged that the past reproduction for the data block is continued) (the step S103: No), the operational flow returns to the step S101, and the reproduction operation is continued.

On the other hand, as a result of the judgment in the step S103, if it is judged that the reproduction for one data block is newly started (the step S103: Yes), then, the waveform distortion amount D′ is calculated by the operation of the offset calculation circuit 18c (step S131). Then, the offset value OFS corresponding to the waveform distortion amount D′ is added to the read sample value series R_{SC} (the step S105).

Alternatively, the offset value OFS may be added if there is a reproduction error in the reproduction operation. Specifically, as shown in FIG. 21, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not a value of SER (Symbol Error Rate) is normal (the step S111).

As a result of the judgment in the step S111, if it is judged that the value of SER is normal (the step S111: Yes), the operational flow returns to the step S101, and the reproduction operation is continued.

On the other hand, as a result of the judgment in the step S111, if it is judged that the value of SER is not normal (the step S111: No), then, the waveform distortion amount D′ is calculated by the operation of the offset calculation circuit 18c (the step S131). Then, the offset value corresponding to the waveform distortion amount D′ is added to the read sample value series RS_{C} (the step S105).

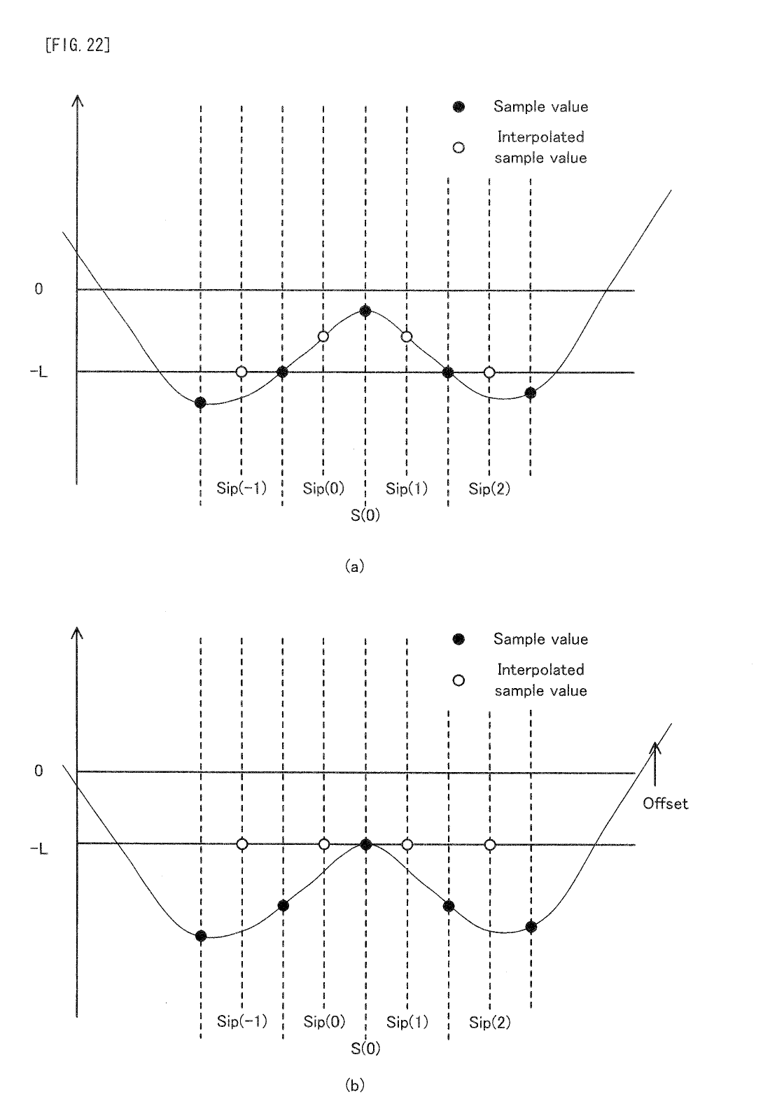

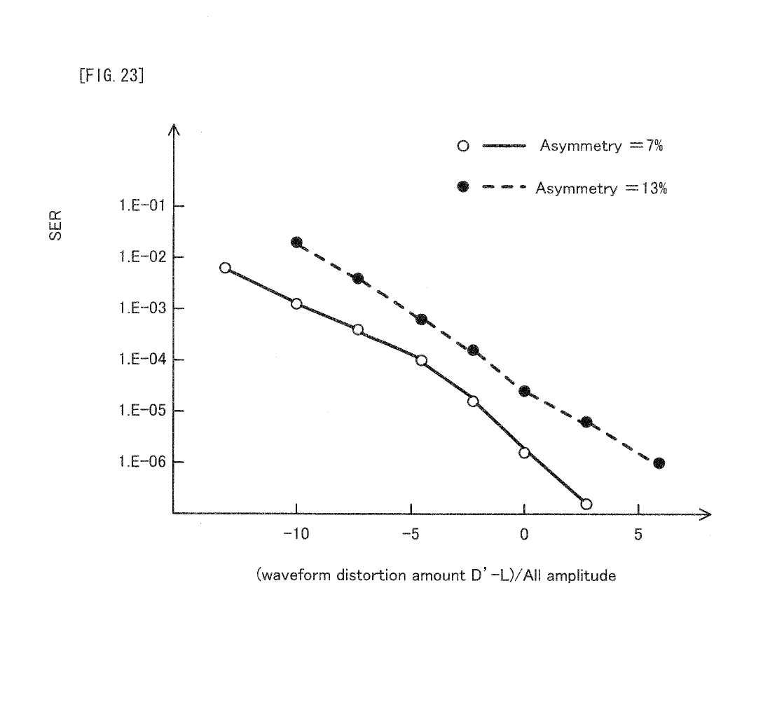

As described above, by adding the offset value OFS corresponding to the waveform distortion amount D′ to the read sample value series R_{SC}, it is possible to receive the aforementioned various effects while eliminating the influence due to the value (i.e. the influence due to the deviation of the amplitude center). The effect that the influence due to the waveform distortion is eliminated will be explained with reference to FIG. 22 and FIG. 23. FIG. 22 are waveform charts conceptually showing an operation of obtaining a high-frequency emphasized read sample value series RS_{H}, in each of a case where the zero level is set without adding the offset value OFS corresponding to the waveform distortion amount D to the read sample value series R_{SC} and a case where the zero level is adjusted by adding the offset value OFS corresponding to the waveform distortion amount D to the read sample value series R_{SC}, on the sample value series R_{SC} with the waveform distortion. FIG. 23 is a graph showing a change in symbol error rate with respect to a positional relation between the upper limit or lower limit of the amplitude limit value and the waveform distortion.

As shown in FIG. 22(a), if there is the waveform distortion, the waveform distortion may have a signal level that is greater than the lower limit −L of the amplitude limit value. Here, it is assumed that the operations by the amplitude limit block 152 and the high-frequency emphasis block 153 are performed without adding the offset value OFS (=D′−L) corresponding to the waveform distortion amount D′ to the read sample value series R_{SC} (i.e. without adjusting the zero level) In this case, the high-frequency emphasized read sample value series RS_{H} outputted from the high-frequency emphasis block 153 is the sum of the high-frequency read sample value series RS_{HIG} and S(0), and as described above, RS_{HIG}=(−k)×Sip(−1)+k×Sip(0)+k×Sip(1)+(−k)×Sip(2). Here, since Sip(−1) and Sip(2) are limited by the lower limit −L, RS_{H}=S(0)+k×(−2L2+Sip(0)+Sip(1)). This increases the value of the high-frequency emphasized read sample value series RS_{H}, by the value obtained by multiplying the sum of the lower limit −L, Sip(0), and Sip(1) by K. This is not preferable because it emphasizes the waveform distortion which is originally not to occur.

On the other hand, as shown in FIG. 22(b), it is assumed that the operations by the amplitude limit block 152 and the high-frequency emphasis block 153 are performed by adding the offset value OFS (=D′−L) corresponding to the waveform distortion amount D′ to the read sample value series R_{SC} (i.e. without adjusting the zero level). In this case, the zero level is shifted in a direction away from the waveform distortion (i.e. on the opposite side to the side where the waveform distortion occurs). Thus, a new lower limit −L does not cross the waveform corresponding to the waveform distortion. In other words, the addition of the offset value OFS to the read sample value series R_{SC} is performed in order to shift the zero level in the direction away from the waveform distortion or in order not to make the lower limit of the lower limit of the amplitude limit value cross the waveform distortion. Thus, since Sip(−1), Sip(0), Sip(1), and Sip(2) are limited by the lower limit −L, RS_{H}=S(0). Thus, it is possible to prevent the disadvantage of the emphasized waveform distortion.

As described above, the effect of the information reproducing apparatus 1 that the offset value OFS corresponding to the waveform distortion amount D′ is added to the read sample value series R_{SC} as described above is also seen from a change in symbol error rate with respect to the positional relation between the upper limit or lower limit of the amplitude limit value and the waveform distortion. As shown in FIG. 23, compared to the case where the lower limit and the waveform distortion cross each other (i.e. if −L + the waveform distortion amount D′ is negative), the value of SER is improved in the case where the lower limit −L and the waveform distortion do not cross each other (i.e. if −L + the waveform distortion amount D′ is positive). Of course, the same is true for a change in symbol error rate with respect to the positional relation between the upper limit L of the amplitude limit value and the waveform distortion.

Incidentally, in the case where the offset value OFS corresponding to the waveform distortion amount D′ is added to the read sample value series R_{SC} as described above, it is preferable that the lower limit of the amplitude does not cross the waveform distortion. In order not to make the zero level cross the waveform distortion, the offset value OFS corresponding to the waveform distortion amount D′ may be added to the sample value series R_{SC}.

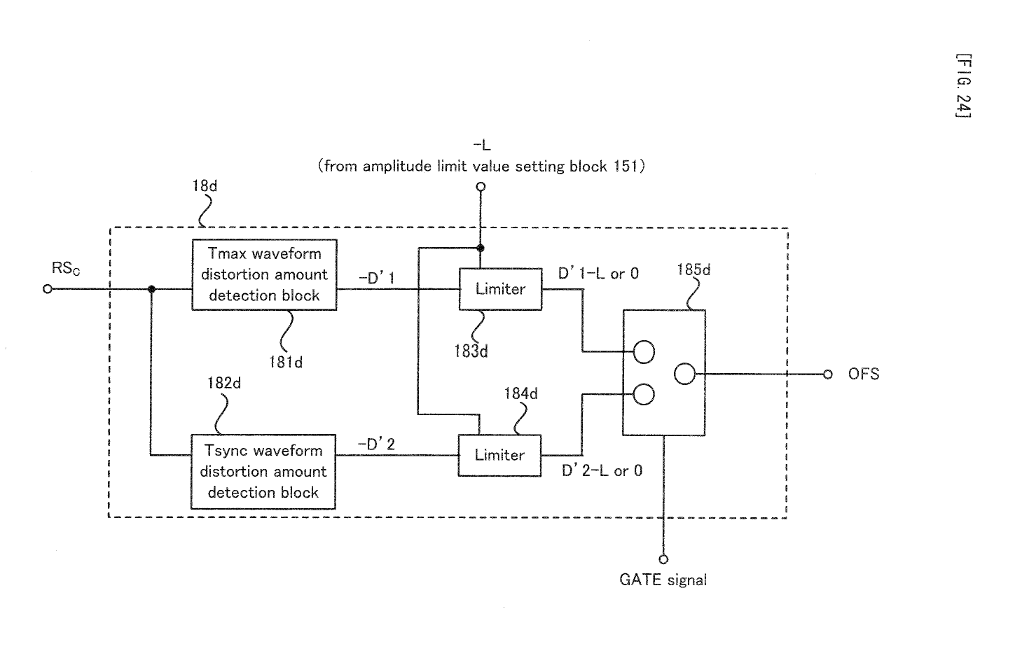

Incidentally, the record data recorded on the optical disc 100 includes not only normal user data but also synchronization data (e.g. the record data with a run length of 14T if the optical disc 100 is a DVD, and the record data with a run length of 9T if the optical disc 100 is a Blu-ray Disc) used for synchronization in reproducing the user data. In view of that the synchronization data is included in the record data, the offset value OFS may be calculated on the basis of the waveform distortion amount D′, using construction shown in FIG. 24. FIG. 24 is a block diagram conceptually showing the structure of an offset calculation circuit 18d for calculating an offset value OFS on the basis of the waveform distortion amount D′ in view of that the synchronization data is included in the record data.

As shown in FIG. 24, the offset calculation circuit 18d is provided with a Tmax waveform distortion amount detection block 181d, a Tsync waveform distortion detection block 182d, a limiter 183d, a limiter 184d, and a selector 185d.

The Tmax waveform distortion amount detection block 181d has the same structure as that of the aforementioned offset calculation circuit 18c. In other words, the Tmax waveform distortion amount detection block 181d detects a waveform distortion amount D′1 of the read signal corresponding to the record data with a run length of Tmax. Incidentally, in the example of the waveform distortion shown in FIG. 17, since the waveform distortion occurs at the zero level or less, the outputted waveform distortion amount is −D′1.

The Tsync waveform distortion detection block 182d has such a structure that the Tmax detection circuit 182c of the aforementioned offset calculation circuit 18c is replaced by a Tsync detection circuit. In other words, the Tsync waveform distortion detection block 182d detects a waveform distortion amount D′2 of the read signal corresponding to the record data with a run length of Tsync. Incidentally, in the example of the waveform distortion shown in FIG. 17, since the waveform distortion occurs at the zero level or less, the outputted waveform distortion amount is −D′2.

Incidentally, Tsync indicates the read signal R_{RF} (more specifically, the read sample value series R_{SC} corresponding to the read signal R_{RF}) corresponding to the synchronization data (in other words, sync data). For example, Tsync is the read signal R_{RF} corresponding to the record data with a run length of 14T if the optical disc 100 is a DVD. For example, Tsync is the read signal R_{RF} corresponding to the record data with a run length of 9T if the optical disc 100 is a Blu-ray Disc.

A waveform distortion amount −D1 detected on the Tmax waveform distortion amount detection block 181d is subjected to the limit by the lower limit −L which is set by the amplitude limit value setting clock 151, on the limiter 183d. In other words, if the waveform distortion amount −D′1 has a value of the lower limit −L or less (i.e. if the waveform distortion of the read signal of Tmax does not cross the lower limit −L), zero is outputted as the offset value OFS to the selector 185d. If the waveform distortion amount −D′1 has a value of the lower limit −L or more (i.e. if the waveform distortion of the read signal of Tmax crosses the lower limit −L), D′1 −L is outputted as the offset value OFS to the selector 185d.

In the same manner, a waveform distortion amount −D2 detected on the Tsync waveform distortion detection block 182d is subjected to the limit by the lower limit −L which is set by the amplitude limit value setting clock 151, on the limiter 183d. In other words, if the waveform distortion amount −D′2 has a value of the lower limit −L or less (i.e. if the waveform distortion of the read signal of Tsync does not cross the lower limit −L), zero is outputted as the offset value OFS to the selector 185d. If the waveform distortion amount −D′2 has a value of the lower limit −L or more (i.e. if the waveform distortion of the read signal of Tsync crosses the lower limit −L), D′2−L is outputted as the offset value OFS to the selector 185d.

On the selector 185d, the offset value OFS is outputted by changing the output of each of the limiter 183d and the limiter 184d as occasion demands, on the basis of a GATE signal having a rising pulse in timing that the synchronization data appears. Specifically, in the timing that there is no rising pulse by the GATE signal (i.e. in the timing that the normal user data is reproduced), the output of the limiter 183d is outputted as the offset value OFS. On the other hand, in the timing that there is a rising pulse by the GATE signal (i.e. in the timing that the synchronization data is reproduced), the output of the limiter 184d is outputted as the offset value OFS.

As described above, by calculating the offset value OFS on the basis of the waveform distortion amount D′ in view of that the synchronization data is included in the record data, it is possible to preferably perform high-frequency emphasis on the synchronization data, which is more important than the user data, resulting in preferable reproduction of the synchronization data. By this, it is possible to further improve stability in the reproduction operation.

Incidentally, in the example shown in FIG. 24, the offset value OFS is calculated by changing the waveform distortion amount −D′1 of the user data and the waveform distortion amount −D′2 of the synchronization data, as occasion demands. However, with emphasis on the importance of the synchronization data, the offset value OFS may be calculated by always using the waveform distortion amount −D′2 of the synchronization data.

Moreover, in the explanation in FIG. 24, an explanation was given on the operation aimed at the optical disc 100 in which the reflectance of the laser beam LB is reduced by recording the record data. However, it may be aimed at the optical disc 100 in which the reflectance of the laser beam LB is increased by recording the record data. In this case, each of the limiters 183d and 184d in the offset calculation block 18d shown in FIG. 24 performs the level limit according to the upper limit L of the amplitude limit value outputted from the amplitude limit value setting block 151. Thus, if the waveform distortion amount D′1 has a value of the upper limit L or more (i.e. the waveform distortion of the read signal of Tmax does not cross the upper limit L), zero is outputted as the offset value OFS to the selector 185d from the limiter 183d. If the waveform distortion amount D′1 has a value of the upper limit L or less (i.e. the waveform distortion of the read signal of Tmax crosses the upper limit L), L−D′1 is outputted as the offset value OFS to the selector 185d. In the same manner, if the waveform distortion amount D′2 has a value of the upper limit L or more (i.e. the waveform distortion of the read signal of Tmax does not cross the upper limit L), zero is outputted as the offset value OFS to the selector 185d from the limiter 184d. If the waveform distortion amount D′2 has a value of the upper limit L or less (i.e. the waveform distortion of the read signal of Tmax crosses the upper limit L), L−D′2 is outputted as the offset value OFS to the selector 185d.

Incidentally, in the example, the asymmetry value Asy, the value, and the waveform distortion amount D′ are used, as they are, as the offset value OFS. However, an appropriate value may be also set as the offset value OFS in accordance with the asymmetry value Asy, the value, and the waveform distortion amount D′ which are detected. In other words, a value specified by a predetermined function or the like which uses the asymmetry value Asy, the value, and the waveform distortion amount D′ as variables may be set as the offset value OFS.

Moreover, in the example, an explanation was given on the construction that the offset value OFS calculated in accordance with the asymmetry value Asy, the value, and the waveform distortion amount D′ is added; however, an arbitrary offset value may be added. Alternatively, zero level may be set to an arbitrary value.

### (3) Modified Example

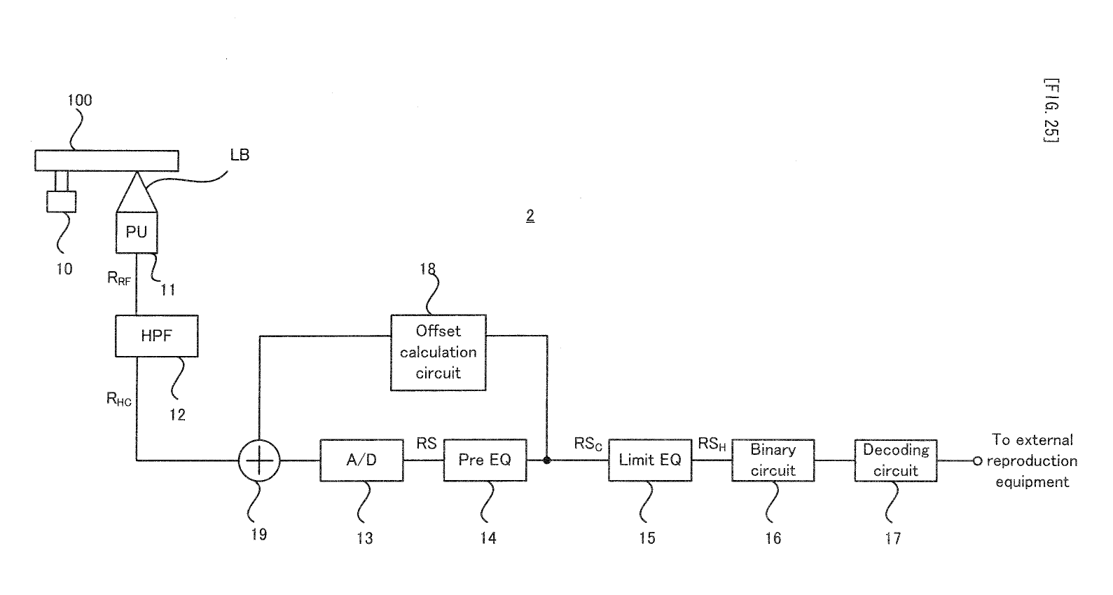

Next, with reference to FIG. 25, an information reproducing apparatus in a modified example will be explained. FIG. 25 is a block diagram conceptually showing the basic structure of an information reproducing apparatus 2 in the modified example.

As shown in FIG. 25, on the information reproducing apparatus 2 in the modified example, the offset value OFS calculated on the offset calculation circuit 18 is added to the read signal R_{HC} outputted form the HPF 12. In other words, in the structure shown in FIG. 1, the offset value OFS calculated on the offset calculation circuit 18 is added to the read sample value series R_{SC} in a digital manner; however, it may be added to the read sample value series R_{SC} in an analog manner. Even in such construction, it is possible to preferably receive the aforementioned various effects as described above.

Incidentally, the aforementioned explanation describes the optical disc 100 in which the reflectance of the laser beam is reduced by recording the data. However, obviously, the same operation may be performed on an optical disc in which the reflectance of the laser beam is increased by recording the data.

The present invention is not limited to the aforementioned example, but various changes may be made, if desired, without departing from the essence or spirit of the invention which can be read from the claims and the entire specification. An information reproducing apparatus and method, and a computer program, all of which involve such changes, are also intended to be within the technical scope of the present invention.

1. An information reproducing apparatus comprising-an amplitude limiting device for obtaining an amplitude limit signal by limiting an amplitude level of a read signal read from a recording medium on the basis of a predetermined amplitude limit value; a filtering device for obtaining an equalization-corrected signal by performing a high-frequency emphasizing and filtering process on the amplitude limit signal; and an adjusting device for variably adjusting a reference level which indicates a reference point of the amplitude level on said amplitude limiting device.

2. The information reproducing apparatus according to claim 1, wherein said adjusting device adjusts the reference level such that the reference level is a median of a signal level of the read signal obtained by reading record data with the shortest run length.

3. The information reproducing apparatus according to claim 1, wherein said adjusting device adjusts the reference level on the basis of at least one of an asymmetry value, a β value, and a waveform distortion amount of the read signal.

4. The information reproducing apparatus according to claim 1, wherein said adjusting device adjusts the reference level by adding an offset value set in accordance with at least one of an asymmetry value, a β value, and a waveform distortion amount of the read signal.

5. The information reproducing apparatus according to claim 3, wherein said adjusting device adjusts the reference level such that the reference level does not cross the waveform distortion.

6. The information reproducing apparatus according to claim 3, wherein said adjusting device adjusts the reference level such that at least one of an upper limit and a lower limit of the amplitude limit value does not cross the waveform distortion.

7. The information reproducing apparatus according to claim 3, wherein said adjusting device adjusts the reference level such that the reference level is shifted to a side which is opposite to a side where the waveform distortion occurs.

8. The information reproducing apparatus according to claim 3, wherein said adjusting device adjusts the reference level in limiting the amplitude level of the read signal corresponding to user data of record data, in accordance with the waveform distortion amount of the read signal corresponding to the user data, and said adjusting device adjusts the reference level in limiting the amplitude level of the read signal corresponding to synchronization data of record data, in accordance with the waveform distortion amount of the read signal corresponding to the synchronization data, the synchronization data being used for synchronization when the user data is reproduced.

9. The information reproducing apparatus according to claim 1, wherein said adjusting device adjusts the reference level if there is a read error.

10. An information reproducing method comprising: an amplitude limiting process of obtaining an amplitude limit signal by limiting an amplitude level of a read signal read from a recording medium on the basis of a predetermined amplitude limit value; a filtering process of obtaining an equalization-corrected signal by performing a high-frequency emphasizing and filtering process on the amplitude limit signal; and an adjusting process of variably adjusting a reference level which indicates a reference point of the amplitude level in said amplitude limiting process.

11. A computer readable recording medium recording thereon a computer program for reproduction control and for controlling a computer provided in an information reproducing apparatus comprising: an amplitude limiting device for obtaining an amplitude limit signal by limiting an amplitude level of a read signal read from a recording medium on the basis of a predetermined amplitude limit value; a filtering device for obtaining an equalization-corrected signal by performing a high-frequency emphasizing and filtering process on the amplitude limit signal; and an adjusting device for variably adjusting a reference level which indicates a reference point of the amplitude level on said amplitude limiting device, said computer program making the computer function as at least one portion of said amplitude limiting device, said filtering device, and said adjusting device.
